(19) United States
(12) Patent Application Publication
(10) Pub. No.: US 2005/0038222 A1
(43) Pub. Date: Feb. 17, 2005

(54) Process for filament winding

(76) Inventors: Ravi R. Joshi, Stevenson Ranch, CA (US); Evan H. Cheolas, Sterling Heights, MI (US)

Correspondence Address: Patent Counsel;Huntsman Polyurethanes, 286 Mantua Grove Road, West Deptford, NJ, 08066-1732, US

(21) Appl. No.: 10/947,113

(22) Filed: Sep. 21, 2004

Related U.S. Application Data
(63) Continuation of application No. PCT/US03/09416, filed on Mar. 27, 2003.
(60) Provisional application No. 60/368,479, filed on Mar. 29, 2002.
(60) Provisional application No. 60/401,583, filed on Aug. 6, 2002.

(51) Int. Cl. C08G 18/00

(52) U.S. Cl. 528/44

(57) ABSTRACT

Filament winding process based on the mixing initiated polymerization of an at least two-component resin system, the system comprising an organic polyisocyanate and a polyfunctional active hydrogen composition as the principle isocyanate reactive species. The invention further provides improved composite articles produced by the filament winding process.

### CROSS-REFERENCE TO RELATED APPLICATIONS

This application claims priority to U.S. Provisional Application Ser. No. 60/368,479, which was filed on Mar. 29, 2002, and U.S. Provisional Application Ser. No. 60/401,583, which was filed on Aug. 6, 2002. This application is also a continuation of international application PCT/US03/09416, filed Mar. 27, 2003.

### FIELD OF THE INVENTION

The invention relates to filament winding.

### BACKGROUND OF THE INVENTION

Filament winding is a very well known process for the production of composites. It is particularly well suited for the production of composites based on a crosslinking (thermoset) matrix resin. In a typical filament winding operation, a continuous filament of reinforcing material, such as glass fiber, is passed through a liquid resin bath and then wound around a mandrel in order to form a hollow cylindrical object. The resin is cured by application of heat and/or radiation in order to form the final composite shaped article.

Most of the thermoset resins used in filament winding are applied to the filament as a single liquid component (one component system). Well-known examples of such resins include unsaturated polyester resins, epoxy resins, and vinyl ester resins. The unsaturated polyesters and the vinyl esters are usually diluted with a reactive unsaturated monomer, such as styrene or methyl methacrylate, which reacts into the matrix polymer structure during cure. The one component thermosetting liquid resins used in filament winding also often contain cure catalysts and other additives formulated into the single liquid resin component.

The presence of unsaturated volatile monomers, such as styrene, in many of the most common types of resin systems used in thermoset filament winding is generally necessary for the control of resin viscosity and flow, and for the development of the desired physical properties in the final composite. Unfortunately, the volatile nature of these monomers is causing increased environmental, health, and safety concerns in the industry. Therefore, there is a growing need to find environmentally acceptable replacements for such resins (i.e. resins that are substantially free of volatile organic compounds (VOC's)) that are cost effective and provide adequate processing characteristics, without sacrificing the physical properties in the final filament wound composite article. Achieving this combination has been difficult. Another problem with the known one-component thermosetting resins used in filament winding is excessive dripping of resin during the production and curing of the composite article. It would be desirable to have a thermosetting resin system that provides good flowability and fiber wetting, but with less dripping.

Thermosetting reins based on polyisocyanate chemistry have not been widely used in filament winding. This is generally due to the fact that polyisocyanate resin chemistry is mixing activated. It requires the accurate combination of two or more chemical precursors, such as a polyisocyanate and a polyol, at a well-defined stoichiometry. Part of the problem with this mixing activated technology is the difficulty in controlling the reaction. Polyisocyanates and active hydrogen resins generally begin reacting on contact, even at ambient temperature without a catalyst. If the reaction is too fast, it will gel prematurely and cause fouling of the processing apparatus or defects in the final parts. If the cure is too slow the process may not be economical. A delicate balance must be struck. Another serious difficulty with mixing activated polyisocyanate-based resin systems in filament winding is the tendency of isocyanates, especially aromatic isocyanates, to react with moisture and cause foaming. When properly controlled, foaming may be a benefit in some applications. However, foaming is very difficult to eliminate completely in polyisocyanate resin technology. Foaming can also be difficult to control in applications where the resin must remain on the reinforcing fiber (filament) for a period of time prior to cure. If the release of gas is not precisely managed, it will cause part defects that could result in part failure in use.

Polyisocyanate based resins have been used in thermoset filament winding technology in the past, but this has usually been by a pseudo one component method. In this method, a polyisocyanate is combined with an isocyanate reactive resin that is selected to be relatively unreactive towards the polyisocyanate at ambient temperatures, but reacts at elevated temperatures in the presence of a catalyst. A known example of this approach in filament winding is the formation of oxazolidone linkages from the reaction of a polyisocyanate with a polyepoxide (epoxy) resin. This method is disclosed in U.S. Pat. No. 4,576,768. There are several other references to the oxazolidone forming reaction of polyisocyanates in thermally activated processes for forming composites by filament winding. Reference to similar chemistry in a filament winding process is made in Revue Generale de l'Electricite, No.11, pg 28-31, 1989 “Fire Resistant Composite Structures for Electrical Insulation”, and Composites (Paris), Vol.29, No. 3, pg 184-187, 1989, “Recent Progress in High Temperature Resisting Composite Structures”. The oxazolidone approach described in these references has some advantages, but the reaction is difficult to drive to completion. It would be desirable to be able to use more conventional polyisocyanate based chemistries, such as the polyurethane and polyisocyanurate reactions, in making composites by filament winding.

It is therefore an object of the invention described herein to provide a process for the production of filament wound composites based on the mixing activated reaction of an organic polyisocyanate with a polyfunctional organic active hydrogen resin, wherein said polyfunctional organic active hydrogen resin is the principle isocyanate reactive species in the polymer forming reaction system by weight. It is a further object of the invention to provide a process for the production of filament wound composites by using a mixing activated resin system that is substantially free of volatile organic compounds. It is a still further object of the invention to provide such a mixing activated reaction system that provides suitable processing characteristics in the filament winding process and desirable physical properties in the filament wound composites produced according to the process.

### SUMMARY OF THE INVENTION

In one embodiment, the present invention relates to a filament winding process based upon a mixing activated, polymer forming, resin reaction system. The process comprised the following steps:
A) Providing an organic polyisocyanate;
B) Providing an organic polyfunctional active hydrogen resin, said resin containing active hydrogen groups which are reactive towards organically bound isocyanate groups;
C) Optionally providing a catalyst for the reaction of organically bound isocyanate groups with active hydrogen groups;
D) Providing a reinforcing filament;
E) Providing a mixing means suitable for mixing the organic polyisocyanate with the organic polyfunctional active hydrogen resin at a controlled ratio;
F) Mixing the organic polyisocyanate with the organic polyfunctional active hydrogen resin at a suitable ratio, in order to form a reaction mixture;
G) Applying the reaction mixture to the filament in order to form a resin treated filament;
H) Winding the resin treated filament around a mandrel in order to form a shaped article;
I) Curing the resin in order to form a cured shaped article and removing the cured shaped article from the mandrel;
wherein said organic polyfunctional active hydrogen resin is the principle, and preferably the only, isocyanate reactive material in the reaction mixture by weight; and wherein the said reaction mixture is substantially free of styrene, methyl methacrylate, and organic resins or organic monomers boiling at less than 185° C. at 1 atmosphere pressure (760 mmHg).

In a preferred embodiment of the invention, the reaction mixture is substantially free of organic species, other than carbon dioxide, boiling less than 195° C. at 1 atmosphere pressure (760 mmHg). In a highly preferred embodiment of the invention, the reaction mixture is substantially free of organic species, other than carbon dioxide, boiling less than 200° C. In a more highly preferred embodiment of the invention, the reaction mixture is substantially free of organic species, other than carbon dioxide, boiling less than 250° C. at 1 atmosphere pressure (760 mmHg). In a still more highly preferred embodiment, the reaction mixture is substantially free of such organic species boiling less than 260° C. at 1 atmosphere pressure (760 mmHg). In yet another highly preferred embodiment of the invention, the reaction mixture is substantially free of organic species other than carbon dioxide having a vapor pressure greater than or equal to 0.1 mmHg at 25° C. In still another highly preferred embodiment of the invention, the reaction mixture is substantially free of any organic species having a vapor pressure greater than or equal to 0.1 mmHg at 25° C.

The term “1 atmosphere pressure” will be understood herein to denote the standard atmospheric pressure (at sea level), of 760 mmHg.

In a particularly preferred embodiment, the said organic polyisocyanate consists essentially of one or more polyisocyanates of the MDI series.

The preferred process of the invention is a two-component mixing activated process wherein the two components forming the reaction mixture are the organic polyisocyanate and the organic polyfunctional active hydrogen resin, and wherein the latter component contains any optional additives. In the most preferred embodiments of the invention, the reaction between the organic polyisocyanate and the organic polyfunctional active hydrogen resin (in the presence of any optional catalysts) begins at the point of mixing thereof to form the said reaction mixture. In these most preferred embodiments, the said reaction mixture exhibits a gel time, as measured from the completion of mixing, at 25° C., of 1500 seconds or greater, still more preferably between 1500 seconds and 1900 seconds, and said reaction system further exhibits a gel time, also as measured from the completion of mixing, at 45° C., of from 25 seconds to 45 seconds.

The mixing activated polymer forming resin reaction systems used in the filament winding process according to the invention are preferably thermosetting systems that cure by forming a covalently crosslinked network structure. Such systems will be referred to herein as “crosslinking systems” or “crosslinking reaction mixtures”. The reaction systems preferably contain one or more polymer forming monomers having a functionality of greater than 2. More preferably, the organic polyisocyanate composition or the organic polyfunctional active hydrogen resin composition has a number averaged functionality of greater than 2. Even more preferably, both the organic polyisocyanate composition and the organic polyfunctional active hydrogen resin composition each have number averaged functionalities of greater than 2. Covalent crosslinking may also be achieved by the use of one or more of the known self reactions of the isocyanate group which produce branching, most preferably, the isocyanurate reaction (also known as the trimerization reaction).

### DETAILED DESCRIPTION OF THE INVENTION

In one embodiment, the filament winding process according to the invention comprises the following steps:

A) Providing an Organic Polyisocyanate:

The organic polyisocyanate composition preferably consists of organic polyisocyanates having a number averaged isocyanate (—NCO) functionality of from at least 1.8 to about 4.0. In practicing the more preferred embodiments of the filament winding process according to the invention, the number averaged isocyanate functionality of the polyisocyanate composition is preferably from 2.0 to about 3.0, more preferably from greater than 2.0 to abut 3.0, and still more preferably from 2.3 to 2.9.

The expression “organic polyisocyanate” will be understood to encompass isocyanate molecular species having a plurality of organically bound isocyanate (—NCO) groups. This definition includes organic diisocyanates, triisocyanates, higher functionality polyisocyanates, and mixtures thereof.

The organic polyisocyanates, which may be used in the process of present invention, include any of the aliphatic, cycloaliphatic, araliphatic, or aromatic polyisocyanates known to those skilled in the art. Especially preferred are those polyisocyanates that are liquid at 25° C. Examples of suitable polyisocyanates include 1,6-hexamethylenediisocyanate; isophorone diisocyanate; 1,4-cyclohexane diisocyanate; 4,4′-dicyclohexylmethane diisocyanate; 1,4-xylylene diisocyanate; 1,4-phenylene diisocyanate; 2,4-toluene diisocyanate; 2,6-toluene diisocyanate; 4,4′-diphenylmethane diisocyanate (4,4′-MDI); 2,4′-diphenylmethane diisocyanate (2,4′-MDI); polymethylene polyphenylene polyisocyanates (crude, or polymeric, MDI); and 1,5-naphthalene diisocyanate. Mixtures of these polyisocyanates can also be used. Moreover, isocyanate-functional polyisocyanate variants, for example polyisocyanates which have been modified by the introduction of urethane, allophanate, urea, biuret, carbodiimide, uretonimine, isocyanurate, and/or oxazolidone residues can also be used in the present systems.

In general, aromatic polyisocyanates are more preferred for use in the process of the present invention. The most preferred aromatic polyisocyanates are 4,4′-MDI, 2,4′-MDI, polymeric MDI, MDI variants, and mixtures of these. Isocyanate terminated prepolymers may also be employed. Such prepolymers are generally prepared by reacting a molar excess of polymeric or pure polyisocyanate with one or more polyols. The polyols may include aminated polyols, imine or enamine modified polyols, polyether polyols, polyester polyols or polyamines. Pseudoprepolymers (also known as semiprepolymers or quasiprepolymers), which are a mixture of one or more isocyanate terminated prepolymer with one or more monomeric polyisocyanates, may also be used. The use of prepolymers and especially pseudoprepolymers is a preferred method for modifying the mechanical properties of the matrix resin. The use of prepolymers and pseudoprepolymers is also a useful technique for control of the weight ratios of the reactive components during processing.

Although it is within the scope of the invention to incorporate polyisocyanates that are fully or partially blocked, it is much more preferable not to use any blocked isocyanate species. Free isocyanate (—NCO) groups are strongly preferred. Consequently, the polyisocyanate should be essentially free of blocked isocyanate groups.

Commercially available polyisocyanates useful in the preferred two-component isocyanate-based process according to the present invention include the RUBINATE® brand polymeric isocyanates available from Huntsman International LLC. A specific example of a preferred polyisocyanate composition particularly suitable for use in the improved filament winding process of the invention is RUBINATE 8700 isocyanate. This liquid isocyanate is of the polymeric MDI type and has an —NCO content of 31.5% by weight and a number averaged isocyanate group functionality of 2.7.

B) Providing an Organic Polyfunctional Active Hydrogen Resin:

The organic polyfunctional active hydrogen resin according to the process of the invention comprises a composition containing a plurality of active hydrogen groups that are reactive towards organic isocyanate groups under the conditions of processing. The organic polyfunctional active hydrogen resin preferably comprises at least one organic polyol, wherein said organic polyol has a number averaged functionality of organically bound primary or secondary alcohol groups of at least 1.8. In practicing the filament winding process according to the invention, the number averaged functionality of said polyol is from 1.8 to 10, more preferably from 1.9 to 8, still more preferably from 2 to 6, even more preferably from greater than 2.0 to 6, and most preferably from 2.3 to 4. More preferably, the organic polyfunctional active hydrogen resin consists predominantly, on a weight basis, of a polyol or mixture of polyols. Most preferably, the organic polyfunctional active hydrogen resin consists essentially of one or more polyols. In practicing the filament winding process, in more specific aspects, the organic polyfunctional active hydrogen resin will preferably comprise a mixture of two or more organic polyols. The individual polyols in the mixture will differ principally in regard to hydroxyl group functionality and molecular weight. The organic polyols used in the organic polyfunctional active hydrogen resin are selected from the group consisting of softblock polyols, rigid polyols, and chain extenders or crosslinkers.

Polyols that furnish softblock segments are known to those skilled in the art as softblock polyols or as flexible polyols. Such polyols generally have a number averaged molecular weight of at least about 1500, and preferably from about 1750 to about 8000; a number averaged equivalent weight of from about 400 to about 4000, preferably from about 750 to 2500; and number averaged functionality of isocyanate reactive organic —OH groups of about 1.8 to about 10, and preferably from about 2 to about 4. Such compounds include aliphatic polyether or aliphatic polyester polyols comprising primary and/or secondary hydroxyl groups. In practicing the filament winding process, it is preferred that these softblock polyols comprise from about 0 to about 30% by weight, and more preferably from about 0 to about 20% by weight of the isocyanate reactive species present in the organic polyfunctional active hydrogen resin. Preferred softblock polyols are liquid at 25° C.

Polyols that provide structural rigidity in the derived polymer are referred to in the art as rigid polyols. These are a preferred class for use in the filament winding process of the invention. Such polyols generally have number averaged molecular weights of from 250 to about 3000, preferably from 250 to less than 1500; number averaged equivalent weights of from 80 to about 700, preferably from 85 to about 300; and number averaged isocyanate reactive group functionalities of from 2 to 10, preferably 2 to 4, and more preferably 2 to 3. Such compounds include polyether or polyester polyols comprising primary and/or secondary hydroxyl groups. Preferred rigid polyols are liquid at 25° C.

Polyols that are referred to the in the art as chain extenders and/or crosslinkers are another preferred class for use in the process of the invention. These have molecular weights between 60 to less than 250, preferably from 60 to about 100; equivalent weights from 30 to less than 100, preferably 30 to 70; and isocyanate-reactive group functionalities of from 2 to 4, and preferably from 2 to 3. Examples of suitable chain-extenders/crosslinkers are simple glycols and triols such as ethylene glycol, propylene glycol, dipropylene glycol, 1,4-butanediol, 1,3-butanediol, triethanolamine, triisopropanolamine, tripropylene glycol, diethylene glycol, triethylene glycol, glycerol, mixtures of these, and the like. The most preferred chain-extenders/crosslinkers are liquids at 25° C. Although aliphatic —OH functional compounds, such as those just listed, are the most preferred as chain-extenders/crosslinkers, it is within the scope of the invention to employ certain polyamines, polyamine derivatives, and/or polyphenols. Examples of suitable amines known in the art include diisopropanolamine, diethanolamine, and 3,5-diethyl-2,4-diaminotoluene, 3,5-diethyl-2,6-diaminotoluene, mixtures of these, and the like. Examples of suitable isocyanate reactive amine derivatives include certain imino-functional compounds such as those described in European Patent Application Nos. 284,253 and 359,456, and certain enamino-functional compounds such as those described in European Patent Application No. 359,456 having 2 isocyanate-reactive groups per molecule. Reactive amines, especially aliphatic primary amines, are less preferred due to their extremely high reactivity with polyisocyanates, but may optionally be used if desired in minor amounts.

It is also within the scope of the invention, albeit less preferred, to include within the organic polyfunctional active hydrogen resin minor amounts of other types of isocyanate reactive species that may not conform to the types described above.

The term “chain extender” is used in the art to refer to difunctional low molecular weight isocyanate reactive species, whereas the term “crosslinker” is limited to low molecular weight isocyanate reactive species having a functionality of 3 or more.

A highly preferred organic polyfunctional active hydrogen resin for use in the process of the invention comprises a mixture of (a) about 5 to 20% by weight of at least one polyol having a molecular weight of 1500 or greater and a functionality of 2 to 4; (b) about 40-70% weight of at least one polyol having a molecular weight between 250 and 500 and a functionality of about 3 to about 4, most preferably about 3; and (c) about 10 to about 30% by weight of a least one polyol having a functionality of about 2 and a molecular weight of less than 500. The weights of (a)+(b)+(c) total 100% of the organic polyfunctional active hydrogen resin. All the polyol species in this blend contain essentially all primary and/or secondary aliphatically bound organic —OH groups.

It is to be understood unless otherwise stated that all functionalities, molecular weights, and equivalent weights described herein with respect to polymeric materials are number averaged, and all functionalities, molecular weights, and equivalent weights described with respect to pure compounds are absolute.

The preferred polyols may be of either the polyether or the polyester type. Polyether based polyols, fatty polyester based polyols, and combinations of these are generally the more preferred as the predominant or exclusive polyols by weight in the filament winding process of the invention. The “fatty” polyester polyols are defined below.

It is particularly preferred to avoid using mixtures of polyether and certain polyester type polyols within the organic isocyanate-reactive resin. An exception to this however are the fatty polyester polyols, as defined below. Use of mixtures of polyether polyols with polyester polyols (other than the fatty polyester polyols described below) in the polyol blend can detract from performance. It is much more desirable to use a polyether polyol composition which is substantially free of (non-fatty) polyester polyols, or alternatively a polyester polyol composition which is substantially free of polyether polyols, in the polyol blends for use in the preferred process according to the present invention. The term “substantially free” in this context will be understood to mean less than 10% by weight of the total organic polyfunctional active hydrogen resin, preferably less than 5% by weight, more preferably less than 1% by weight, still more preferably less than 0.5% by weight, even more preferably less than 0.1% by weight, and ideally 0% by weight relative to the total weight of the organic polyfunctional active hydrogen resin.

Suitable polyether polyols which can be employed in the reaction systems of the invention include those which are prepared by reacting an alkylene oxide, a halogen substituted or aromatic substituted alkylene oxide or mixtures thereof, with an active hydrogen containing initiator compound. Suitable oxides include for example ethylene oxide, propylene oxide, 1,2-butylene oxide, styrene oxide, epichlorohydrin, epibromohydrin, mixtures thereof, and the like. Propylene oxide and ethylene oxide are particularly preferred alkylene oxides. Suitable initiator compounds include water, ethylene glycol, propylene glycol, butanediols, hexanediols, glycerine, trimethylolpropane, trimethylolethane, pentaerythritol, hexanetriols, sucrose, hydroquinone, resorcinol, catechol, bisphenols, novolac resins, phosphoric acid, and mixtures of these.

Further examples of suitable initiators include ammonia, ethylenediamine, diaminopropanes, diaminobutanes, diaminopentanes, diaminohexanes, diethylenetriamine, triethylenetetramine, tetraethylenepentamine, pentamethylenehexamine, ethanolamine, aminoethylethanolamine, aniline, 2,4-toluenediamine, 2,6-toluenediamine, 2,4′-diaminodiphenylmethane, 4,4′-diaminodiphenylmethane, 1,3-phenylenediamine, 1,4-phenylenediamine, naphthylene-1,5-diamine, triphenylmethane-4,4′,4″-tramine, 4,4′-di-(methylamino)-diphenylmethane, 1,3-diethyl-2,4-diaminobenzene, 2,4-diaminomesitylene, 1-methyl-3,5-diethyl-2,4-diaminobenzene, 1-methyl-3,5-diethyl-2,6-diaminobenzene, 1,3,5-triethyl-2,6-diaminobenzene, 3,5,3′,5′-tetraethyl-4,4′-diamiodiphenylmethane, and amine aldehyde condensation products such as the crude polyphenylpolymethylene polyamine mixtures produced from aniline and formaldehyde, and mixtures thereof.

Suitable polyester polyols include, for example, those prepared by reacting a polycarboxylic acid or anhydride with a polyhydric alcohol. The polycarboxylic acids may be aliphatic, cycloaliphatic, araliphatic, aromatic, and/or heterocyclic and may be substituted (e.g. with halogen atoms) and/or unsaturated. Examples of suitable carboxylic acids and anhydrides include succinic acid; adipic acid; suberic acid; azelaic acid; sebacic acid; pthtalic acid; isophthalic acid; terephthalic acid; trimellitic acid; phthalic anhydride; tetrahydrophthalic anhydride; hexahydrophthalic anhydride; tetrachlorophthalic anhydride; endomethylene tetrahydrophthalic anhydride; glutaric acid anhydride; maleic acid; maleic anhydride; fumaric acid; dimeric and trimeric fatty acids, such as those obtained from oleic acid, which may be in admixture with monomeric fatty acids. Simple esters of polycarboxylic acids may also be used in preparing polyester polyols. For example, terephthalic acid dimethyl ester, terephthalic acid bis glycol esters, and mixtures of these.

Examples of polyhydric alcohols suitable for use in preparing polyester polyols include ethylene glycol; 1,3-, 1,4-, 1,2-, and 2,3-butanediols; 1,6-hexanediol; 1,8-octanediol; neopentyl glycol; cyclohexane dimethanol (1,4-bis-hydroxymethyl cyclohexane); 2-methyl-1,3-propanediol; glycerol; mannitiol; sorbitol; methylglucoside; diethylene glycol; trimethylolpropane; 1,2,6-hexanetriol; 1,2,4-butanetriol; trimethylolethane; pentaerythritol; triethylene glycol; tetraethylene glycol; polyethylene glycols; dipropylene glycol; tripropylene glycol; polypropylene glycols; dibutylene glycol; polybutylene glycols; mixtures of these; and the like. The polyester polyols may optionally contain some terminal carboxy groups although preferably they are fully hydroxyl terminated. It is also possible to use polyesters derived from lactones such as caprolactone; or from hydroxy carboxylic acids such as hydroxy caproic acid or hydroxyacetic acid.

An especially preferred class of ester-group-containing polyols for use in the organic polyfunctional active hydrogen resin are the fatty ester (or fatty polyester) polyols. Fatty ester (or fatty polyester) polyols comprise at least one alkyl or alkenyl (hydrocarbon) side chain of from 4 to about 50 carbon atoms, preferably 5 to 25 carbon atoms, more preferably 6 to 20 carbon atoms, and most preferably 6 to less than 15 carbon atoms. The alkyl side chains are the more preferred. The fatty ester polyols also comprise at least two primary or secondary aliphatic —OH groups per molecule, and preferably 2 to 4 such —OH groups. The fatty polyester polyols contain at least one carboxylic ester linkages per molecule, and preferably more than one. Preferred examples of fatty ester polyols are those that contain at least one triglyceride structure and are liquid at 25° C. The fatty ester (or fatty polyester) polyols should preferably be free of aromatic rings, although it would be within the scope of the invention to use fatty ester (or fatty polyester) polyols that contain such rings. The fatty (poly)ester polyol may optionally contain ether linkages. A particularly preferred but non-limiting example of a triglyceride based fatty (poly)ester polyol is castor oil. Mixtures of different fatty polyester polyols may be used if desired. The fatty ester polyol may be used by itself, but is preferably used in combination with at least one other type of polyol. The fatty ester polyol is most preferably used in combination with one or more polyether polyols. A preferred range of weight ratios of fatty polyester polyols to polyether polyols, in the isocyanate reactive composition, is from about 1:9 to about 9:1, and more preferably from 1:4 to 4:1. The fatty ester polyols have the desired effect of reducing foaming of the resin system during processing and curing. The fatty ester polyols, and castor oil in particular, appear surprisingly more effective at reducing foaming than conventional drying agents (such as molecular sieves) or conventional defoaming agents (such as silicone based antifoam additives). Even though these optional fatty (poly)ester polyols are preferably used in the isocyanate-reactive component of the reaction system, it would also be within the scope of the invention to use them, in whole or in part, as isocyanate terminated prepolymers in the polyisocyanate component. Although not wishing to be bound by any theory, it is believed that the fatty (poly)ester polyols are particularly effective, however they may be incorporated, because they render the reaction mixture more hydrophobic and thereby retard the reaction of free polyisocyanate groups with adventitious moisture (such as moisture from the air, or moisture on the reinforcing fibers, etc.). The reaction with moisture causes foaming by producing CO₂. If this “hydrophobization” mechanism is correct then it is believed that other hydrophobic polyols and additives might also have this (foam reducing) effect. Examples of hydrophobic polyols that would be expected to have this effect include the hydrocarbon backbone polyols such as the polybutadiene polyols, polyisoprene polyols, polyisobutylene polyols, and/or saturated hydrocarbon polyols prepared by hydrogenation thereof. Polyols of this hydrocarbon-backbone type would preferably have number averaged molecular weights of greater than 400, more preferably greater than 500. Isocyanate group terminated prepolymers of such hydrophobizing polyols might also be used, in the polyisocyanate component of the formulation. Additives which would be expected to have a similar hydrophobizing (foam reducing) effect would include inert hydrocarbon oils such as high boiling aromatic, naphthenic, and/or paraffinic oils. Such oils having initial boiling points greater than 200° C. (at 1 atmosphere pressure) would be most preferred. An example of a particularly preferred oil additive of this type would be VYCEL U-1500 aromatic oil, which is commercially available from Crowley Chemical Co. Inert optional additives such as oils should preferably not be used at levels greater than 10% by weight of the organic resin formulation, preferably not more than 5% by weight.

A particularly preferred example of an isocyanate-reactive polyol is a propylene oxide adduct of glycerol having a nominal functionality of 3 and a number-averaged hydroxyl equivalent weight of 86. This predominantly secondary-OH functional triol is an example of a rigid polyol, as per the description provided hereinabove. It is commercially available from Huntsman Petrochemical Corporation as JEFFOL® G 30-650 polyol. Blends of this preferred polyol with low molecular weight polyoxpropylene glycols, said polyoxypropylene glycols having their molecular weights in the range of from greater than 250 to less than 500, are also examples of preferred polyols. In this preferred polyol composition, the weight ratio of the JEFFOL G 30-650 polyol to the low molecular weight polyoxypropylene glycol is in the range of from about 1:2 to about 4:1, preferably 1:1 to about 3:1, more preferably about 1.5:1 to about 2.5:1, and most preferably about 2:1. A specific example of a particularly preferred low molecular weight polyoxypropylene glycol suitable for use is JEFFOL® PPG-400 glycol, which is available commercially from Huntsman International LLC. This preferred polyol blend preferably comprises about 70 to 100 and more preferably about 80 to about 90% by weight of the organic polyfunctional active hydrogen composition. These binary polyol blends are particularly preferred for making filament wound composites when further mixed with from about 10 to 20% by weight, relative to the total organic polyfunctional active hydrogen resin, of a flexible polyether polyol of molecular weight 2000 or greater. An example of a preferred flexible polyether polyol suitable for use in this highly preferred three component polyol blend is JEFFOL® G 31-32 polyol, which is a nominal polyether triol, commercially available from Huntsman International LLC.

The term “nominal functionality” applied to polyols, as used in the context of this invention, denotes the expected functionality of the polyol based upon the raw materials used in its synthesis. The nominal functionality may differ slightly form actual functionality, but the difference may usually be ignored in the context of this invention. The nominal functionality of a polyoxyalkylene polyether polyol is the functionality of the initiator. This is particularly true for polyether polyols that are based predominantly on EO and/or PO (such as the JEFFOL® G 30-650 polyol described above). The nominal functionality of a pure compound is, of course, the same as its absolute functionality. If a mixed initiator is used, then the nominal functionality of the polyol is the number averaged functionality of the mixed initiator.

The organic polyfunctional active hydrogen resin is the predominant isocyanate reactive material (other than the organic polyisocyanate itself) in the mixing activated chemical formulation used in the filament winding process of the invention. Preferably, this organic polyfunctional active hydrogen resin constitutes at least 90% by weight, more preferably at least 95% by weight, and most preferably at least 98% by weight of the combined isocyanate reactive species (other than the organic polyisocyanate itself) present in the chemical formulation used in the filament winding process of the invention. Preferably, non active-hydrogen functional isocyanate-reactive resins, such as epoxy resins for example, are substantially absent from the chemical formulation. By “substantially free” it is meant that the reaction mixture contains less than 10% by weight of all such non-active-hydrogen functional isocyanate-reactive resins combined, relative to the total weight of the reaction mixture (including all optional additives that may be present). More preferably, the reaction mixture contains less than 5% by weight of all such species combined, relative to the total weight of the reaction system. Still more preferably, the reaction mixture contains less than 2% by weight of such species, even more preferably less than 1%, most preferably less than 0.5%, and ideally less than 0.1%, relative to the total weight of the reaction mixture at the point of mixing.

In a specialized embodiment of the process of the invention, the organic polyfunctional active hydrogen resin may be admixed with minor amounts of water by weight. The water, when used, functions as a foaming agent.

In the more preferred embodiments of the invention, the chemical formulation used in the process (including the polyisocyanate and any optional additives that may be present) is essentially free of water, or other foam generating species. Preferably, the chemical formulation (including the polyisocyanate and any optional additives that may be present) contains less than 0.1% by weight of water or other foam generating species. Still more preferably, this chemical formulation contains less than 0.05% by weight, and ideally 0%, of water or other foam generating species.

C) Optionally Providing a Catalyst for the Reaction of Organically Bound Isocyanate Groups with Active Hydrogen Groups:

Catalysts for the polymer forming reactions of organic polyisocyanates are well known. The optional catalyst package may consist of a single catalyst or a mixture of two or more catalysts. Preferred catalysts are selected from the group consisting of tertiary amines, tertiary amine acid salts, organic metal salts, and combinations of these. Examples of preferred tertiary amine catalysts include triethylenediamine, N,N-dimethyl cyclohexylamine, bis-(dimethylamino)-diethyl ether, N-ethyl morpholine, N,N,N′,N′,N″-pentamethyl diethylenetriamine, N,N-dimethyl aminopropylamine, N-benzyl dimethylamine, and aliphatic tertiary amine-containing amides of carboxylic acids, such as the amides of N,N-dimethyl aminopropylamine with stearic acid, oleic acid, hydroxystearic acid, and dihydroxylstearic acid. Commercially available tertiary amine catalysts include JEFFCAT brand amines from Huntsman International LLC, and POLYCAT brand amines and DABCO brand amine catalysts, both available form Air Products and Chemicals Inc.

Examples of suitable tertiary amine acid salt catalysts include those prepared by the at least partial neutralization of formic acid, acetic acid, 2-ethyl hexanoic acid, oleic acid, or oligomerized oleic acid with a tertiary amine such as triethylenediamine, triethanolamine, triisopropanolamine, N-methyl diethanolamine, N,N-dimethyl ethanolamine, mixtures of these amines, or the like. These amine salt catalysts are sometimes referred to as “blocked amine catalysts”, owing to delayed onset of catalytic activity which provides for improved convenience of resin application.

Examples of preferred organic metal salts for use as catalysts include potassium 2-ethyl hexanoate, potassium oleate, potassium acetate, potassium hydroxide, dibutyltin dilaurate, dibutyltin diacetate, and dibutyltin dioleate.

Further examples of useful catalysts include amido amine compounds derived from the amidization reaction of N,N-dimethyl propanedimine with fatty carboxylic acids. A specific example of such a catalyst is BUSPERSE® 47 catalyst from Buckman Laboratories.

Mixtures of tertiary amine, amine acid salt, and/or metal salt catalysts may be used. The use of mixed catalysts is well known to those skilled in the polymer forming chemistry of polyisocyanates and polyfunctional active hydrogen resins. It is sometimes desirable to include in the mixing activated chemical formulation one or more catalysts for the trimerization of isocyanate groups. Preferred examples of these include the alkali metal salts of carboxylic acids. Some specific examples of isocyanate trimerizaiton (isocyanurate) catalysts include potassium 2-ethyl hexanoate, potassium oleate, potassium acetate, and potassium hydroxide. These are also effective for the catalysis of the reaction of polyisocyanates with active hydrogen compositions such as polyols.

The optional catalysts, regardless of their specific structure or function in the formulation, should preferably be non-volatile species. The more preferred catalysts, therefore, are those having boiling points above 200° C. (at 1 atmosphere pressure), still more preferably above 250° C., and most preferably above 260° C. (at 1 atmosphere pressure).

D) Providing a Reinforcing Filament:

The filament used in filament winding is typically a long continuous or semicontinuous fiber. One or more filaments may be used in the production of any one part. Preferably, one or more single continuous fibers are used for the production of a given filament wound article, and the filament(s) remain unbroken from the beginning to the end of the process for producing said article.

The filaments may be made of any suitable high strength fibrous material. Preferred examples include glass fibers, carbon fibers, metal fibers, nylon fibers, aramide fibers, polyester fibers, natural fibers, combinations of these, and the like. Glass and carbon fibers are particularly important in the filament winding industry. Of these, glass fibers have the advantage of being relatively low in cost.

An individual filament may consist of a single fiber, or of a plurality of fibers that have been combined into a strand by any suitable technique. Suitable filaments may, for example, be braided or wrapped bundles of fibers. In any case, an individual filament can be thought of as an essentially one dimensional strand. The fibers may optionally be pre-treated with a sizing or adhesion promoting surface treatments in order to enhance the bonding thereof to the matrix resin and to improve wetting of the filament by the liquid precursor of the matrix resin (the reaction mixture). In addition to, or separately from, the use of adhesion promoting sizings, the bonding of the matrix resin to the filament may be further enhanced by inclusion, in the reaction mixture, one or more adhesion promoting additives. Organic alkoxysilanes bearing isocyanate reactive functional groups are preferred formulation additives for this purpose.

In addition to the use of individual filaments, it is known in the art and within the scope of the invention to use fibrous mats or veils, braided multifilament tapes, or other more complex, essentially two dimensional, fibrous reinforcing structures that are based upon long fibers. In this broader context the term “filament” also encompasses these essentially two dimensional structures. The use of multifilament tapes is known in the filament winding art. The width and thickness of such multifilament tapes can vary depending upon the nature of the article being produced, as will be appreciated by those skilled in the art. Combinations of tapes and individual filaments may, of course, be used in the production of a particular filament wound composite article if desired.

The size (or diameter) of an individual filament may vary considerably depending upon the needs of the process and the desired characteristics of the final composite. More than one size (diameter) of filament may be used if desired. Typical single end rovings with an average filament diameter ranging from 13 microns to 34 microns are used in the filament winding process.

E) Providing a Mixing Means Suitable for Mixing the Organic Polyisocyanate with the Organic Polyfunctional Active Hydrogen Resin at a Controlled Ratio:

Any suitable mixing means may be employed that provides for control over the stoichiometry of the organic polyisocyanate to organic polyfunctional active hydrogen resin. In the preferred two component liquid mixing activated formulations, the ratio of active hydrogen groups to isocyanate groups is determined by the weight ratio of the organic polyfunctional isocyanate component to the organic polyfunctional active hydrogen resin component. This ratio needs to be carefully controlled, as will be well appreciated by those skilled in the art of isocyanate based polymer chemistry. In certain narrow, but highly preferred, embodiments of the invention the weight ratio of these two components is “fixed”, by the process equipment. The most common fixed ratio is about 1:1. Under these conditions, the two component chemical formulation must be designed to process at this fixed ratio, while giving a suitable reaction stoichiometry. The means for accomplishing this are well known to those skilled in the art of isocyanate based polymer chemistry.

Examples of suitable mixing means include hand mixing. But the preferred means are to use metering pumps or metering pistons for each of the components, and feed the opposing chemical streams into a mixing head that provides for appropriate mixing thereof. Suitable apparatus for accomplishing this is very well known in the art of isocyanate based polymer chemistry, and would be appreciated by one of ordinary skill in this art.

The stoichiometry of mixing activated polymer forming formulations, containing an organic polyisocyanate and a polyfunctional isocyanate reactive resin, is often expressed by a quantity known in the art as the Index. The Index of such a mixing activated formulation is simply the ratio of the total number of reactive isocyanate (—NCO) groups present to the total number of isocyanate-reactive groups (that can react with the isocyanate under the conditions employed in the process). This quantity is often multiplied by 100 and expressed as a percent. Typical index values in these mixing activated formulations range from about 70 to about 150%, but may extend as high as about 1500% if a catalyst for the trimerization of isocyanate groups is present. A preferred range of Index values is from 90 to 110%. Another preferred range of Index values is from 200 to 700%, when a catalyst for the trimerization of isocyanate groups is present.

F) Mixing the Organic Polyisocyanate with the Organic Polyfunctional Active Hydrogen Resin at a Suitable Ratio, in Order to Form a Reaction Mixture;

See also the preceding discussion immediately above (under heading “E”). It is well known in the art of mixing activated polyisocyanate based polymer chemistry to simultaneously control the mixing ratio and the Index of a mixing activated formulation. In the most preferred embodiments of the invention, the reactive formulation consists of just two reactive liquid streams. One stream (often referred to as the A-component) contains the organic polyisocyanate. The second stream (usually referred to as the B-component) contains all the isocyanate reactive ingredients. Optional additives, such as catalysts and surfactants and the like, are usually admixed with the B-component. However, it is within the scope of the invention to incorporate certain additives into the A-component, provided that they are compatible with the isocyanate.

In the most preferred embodiments of the invention, the reaction between the organic polyisocyanate and the organic polyfunctional active hydrogen resin begins as soon as these liquid precursor streams are mixed. This provides for fast processing speeds and rapid cure. However, a careful balance must be struck such that the reaction mixture does not cure too quickly or form solids that cause fouling and part defects.

G) Applying the Reaction Mixture to the Filament in Order to Form a Resin Treated Filament:

The reaction mixture formed from the combining of the polyisocyanate and isocyanate-reactive ingredients (including any optional catalysts and additives which may be present) must remain homogeneous and flowable for a sufficiently long period of time to permit wetting of the filament by the said mixture. It is highly preferred that the reaction should advance in a homogeneous manner, such that no solids or gels are caused to separate from the otherwise liquid mixture. Such solids or gel particles would be highly undesirable in as much as these would likely cause fouling of the filament winding apparatus and/or defects in the final composite parts produced.

The homogeneous reaction mixture is caused to come into contact with the filament such that at least a portion of the surface of the filament is wetted with said reaction mixture. Preferably, most of the surface area of the filament is wetted, and more preferably all of it is wetted with the homogeneous reaction mixture. The wetting of the filament with the liquid reaction mixture may be done on a continuous or a discontinuous basis. Although it is generally preferred that the filament be treated with the reaction mixture, most preferably on a continuous basis, before the filament is wound around the mandrel, in other embodiments of the invention the reaction mixture and the filament may be applied to the mandrel at the same time, or the reaction mixture may be applied to the mandrel before the filament is applied thereto. Combinations of these embodiments may be used if desired. The important consideration in all of these possible variations of the process of the invention is that the reaction mixture is caused to come into contact with the filament.

The filament may be treated with the reaction mixture either before or concurrently with the winding operation, or both. It is generally preferred to conduct the treatment of the filament with the reaction mixture before the winding operation. In this preferred embodiment, the length of time which elapses between when the filament is treated with the reaction mixture and when the winding operation is conducted may vary considerably, provided that the reaction mixture is not fully cured and still retains some degree of flowability when the winding operation begins. The optimum length of this time interval will depend upon the resin system and the conditions employed, as will be recognized by those skilled in the art. Under some special circumstances it may be possible to prepare and store the reaction-mixture treated filament, or some portion thereof, as a “prepreg” (ie. especially if the treated filament is stored below 25 C under dry conditions). Such specialized variations will be understood to be within the scope of the invention, provided that the essential features of the invention as defined herein are satisfied.

H) Winding the Resin Treated Filament Around a Mandrel, in Order to Form a Shaped Article:

The filament that has been wetted by the reaction mixture is caused to be wound around a mandrel which defines the shape of the final composite article. As noted above, the wetting of the filament with the reaction mixture may take place either prior to or concurrently with the winding operation. In a typical embodiment, the filament is wetted on a continuous basis just before it is wound around the mandrel, without any intermediate storage of the wetted filament. This may be accomplished, for example, by running the filament either through a bath or through an injection die before it reaches the mandrel.

The winding operation may, for example, be accomplished by rotating the mandrel while the resin coated filament is under a controlled amount of tension, and moving the filament up and down the length of the mandrel in any desired pattern. Other methods of filament winding will be appreciated by those skilled in the art, and that are usable in the winding step according to the process of this invention.

It is important to minimize the formation of voids or gaps in the filament wound article, by careful control of the winding pattern and the rate of winding. Control of the degree of resin wetting of the filament is also important, with better wetting being generally more preferred. It is important that the resin (ie. the reaction mixture) coating on each loop of filament should overlap with the next completely, and that this should take place while the resin is still flowable to some degree. It is also important at this stage that the reaction taking place in the reaction mixture (i.e. the resin) should remain sufficiently homogeneous that there are no separations of solids or gel particles from the liquid bulk of the resin that would cause either fouling of the winding apparatus or defects in the filament wound parts.

The shape and thickness of the part is influenced by the winding pattern, by the shape of the mandrel, by the number windings, and by the thickness (diameter) of the filaments used. The reinforcement content of the composite (i.e. the percentage by weight of fiber in the total composite) may be varied by varying the amount of reaction mixture on the filament as it is wound. It will also, of course, be influenced by the density of the reinforcement material and the density of the matrix resin. Typical reinforcement content values range from about 30 to about 90 percent by weight of the total composite. In a preferred embodiment the reinforcement content of the composite article ranges from 60 to 70% by weight.

The term “mandrel” will be understood to encompass any suitable shape defining structure around which a resin treated filament may be wound to form a shaped composite part. The mandrel may be a single solid core, a hollow core, an inflatable bladder, or any other shape defining element. The mandrel may be made of a rigid material, a flexible material, or a combination thereof. The preferred mandrels are cylindrical or approximately cylindrical objects, but this need not be the case in every situation. The mandrel may have a very complex internal structure or it may be a very simple cylindrical rod. It may optionally be provided with heating and/or cooling elements within its structure. The mandrel may be designed such that all or part of it is incorporated into the final composite. Alternatively, the mandrel may be designed to be removed from the filament wound composite part. It may optionally be made from a sacrificial material (i.e. a material that is removed from the finished part by dissolving or by selective chemical degradation thereof). A single mandrel, depending upon its design, may be used to produce just one composite part or it might be reused so as to produce a plurality of filament wound parts.

I) Curing the Resin in Order to Form a Cured Shaped Article and Removing the Cured Shaped Article from the Mandrel:

In preferred embodiments, the curing (resin reaction) process begins as soon as the organic polyisocyanate and the organic polyfunctional active hydrogen resin are mixed to form the reaction mixture. However, the extent of this curing must be carefully controlled, as noted above, until the resin application to the filament and the winding of the latter are completed. Moreover, the cure should preferably not be so slow that the resin (reaction mixture) flows off the coated fibers after the winding process. A balance must be struck. As noted above, the cure of the resin should be sufficiently homogeneous as to avoid bulk solids or gels from separating out of an otherwise liquid reaction mixture.

After the winding process is completed, the resin should preferably already be in a partially cured state, but will probably not be completely cured. The extent of cure at the end of the winding process will of course be influenced by the resin formulation itself, and also the conditions (such as the temperature) used during the fiber coating and winding processes. Depending upon the extent of cure after the winding process, the filament wound article may be removed from the mandrel at that point. Alternatively, it may be left on the mandrel until curing is further advanced. The part should not be removed from the mandrel, or excessively handled, until it has sufficient dimensional stability to avoid damage to the part. Whether the part is removed from the mandrel or left on the mandrel, some additional curing will likely be needed. In the case of the mixing activated formulations, the final curing process will most likely involve heating. Although it would certainly be within the scope of the invention to allow curing to proceed at ambient temperature (cold curing), this may not always be practical in industry. In some production situations the heat from the polymerization reaction itself may be sufficient to achieve final cure. Such an arrangement is highly preferred in view of its simplicity. When external heating is deemed to be necessary to achieve the final cure, the temperature and duration of the heating, as well as the heat source used, may vary considerably. The means for optimization of these final curing conditions will be known to those skilled in the art of polyisocyanate reaction chemistry. A non-limiting example of a preferred method of achieving final cure is to place the part in a hot air oven. A typical range of curing temperature, for the final curing stage, would range from about 100° C. to about 300° C., but would more preferably be in the range of about 120° C. to about 250° C., and still more preferably from about 140° C. to about 200° C. The duration of heating required will, of course, depend upon the temperature of the oven and on the resin formulation. It may range from a few minutes to several hours.

It will be appreciated that other means of heating may be used if desired. Non-limiting examples of such alternative heating means include infrared radiation, RF heating, microwave radiation, and combinations of these. The part is preferably allowed to cool after the final cure process. Typically the part may be set aside after final curing for about 24 hours. These conditions may, of course, vary considerably.

A very important factor in the design of the mixing activated formulation for use in the process according to the invention is the gel time. The gelation process should very preferably be homogeneous (as noted above). A balance must also be struck between the need for rapid cure (short cycle time), the need for adequate flowability of the reaction mixture, and the need to prevent excessive flow of resin from the wound part prior to or during the final cure. It has been surprisingly found that this critical balance may be achieved by using a mixing activated system that further conforms to certain gel time windows. In one preferred embodiment, the reaction mixture exhibits a gel time, as measured from the completion of mixing, at 25° C. of from 6 minutes to 24 hours or more, and reaction mixture further exhibits a gel time, also as measured from the completion of mixing, at 50° C. of from 10 seconds to 100 seconds. In another preferred embodiment, the reaction mixture exhibits a gel time, as measured from the completion of mixing, at 25° C. of from 1500 seconds to 1900 seconds, and reaction system further exhibits a gel time, also as measured from the completion of mixing, at 45° C. of from 25 seconds to 45 seconds. In still another preferred embodiment, the reaction mixture exhibits a gel time, as measured from the completion of mixing, at 25° C. of from 1800 seconds to 1860 seconds, and reaction mixture further exhibits a gel time, also measured from the completion of mixing, at 50° C. of from 60 seconds to 90 seconds. In yet another preferred embodiment, the reaction mixture exhibits a gel time, as measured from the completion of mixing, at 25° C. of from 1500 seconds to 1600 seconds, and reaction mixture further exhibits a gel time, also measured from the completion of mixing, at 45° C. of from 25 seconds to 35 seconds. In yet another preferred embodiment, the reaction mixture exhibits a gel time, as measured from the completion of mixing, at 25° C. of from 6 minutes to 24 hours, and reaction mixture further exhibits a gel time, also measured from the completion of mixing, at 50° C. of from 10 seconds to 30 seconds.

The gel times are determined under semi-isothermal conditions at the specified temperature. The gel time is the interval between the time that the reactive components are first mixed to form a reacting liquid mixture until the reacting liquid mixture becomes stringy. This is sometimes called a “string gel” time, and is typically determined by mixing the reactive components of a mixing activated reaction system, said system formulated into two components, in a non-insulated paper cup on a scale of about 100 to 150 g of reaction mixture (most preferably 100 g). The cup is maintained at the required temperature in air. A typical cup size for this purpose would be 350 mls (12 fluid ounces). The gel time is determined by repeatedly touching the polymerizing reaction mixture with a wooden tongue depressor and pulling it away from the liquid. When the material has polymerized to the point where a single or multiple filaments (strings) remain on the end of the tongue depressor, it is termed the string gel time. It is the point where the material has built enough molecular weight to transition from a liquid to a solid. The gel time is measured from the start of the mixing process (i.e. from the time that the two components first make contact). The initial mixing of the reactive liquid components may be accomplished over about 5 to 10 sec with a laboratory drill mixer at about 1200 to 1500 rpm (preferably 1500 rpm).

It has also been found that the use of mixing activated systems in filament winding results in reduced dripping. Because the mixture begins polymerizing as soon as the precursor components are combined, the viscosity of the reaction mixture increases continually during the processing. Yet another advantage of these mixing activated systems is relatively low initial viscosity. This helps with fiber wetting. It has been observed that the preferred mixing activated systems described herein provide both improved (easier) fiber wetting in the process according to the invention and reduced dripping in the later stages of the process (i.e. during winding and curing). This represents a substantial advance over the prior art filament winding processes that use one-component (or pseudo-one-component) thermosetting resin systems.

It is within the scope of the invention to use additives known in the art, other than those explicitly mentioned above. The types of known additives that can be used and the appropriate formulation techniques to be used in incorporating these additives into the reaction mixture will be appreciated by those skilled in the art of polyisocyanate based polymer chemistry. Non-limiting examples of types of additional optional additives which may be used in the chemical formulations suitable for the process of the invention include fire retardants, smoke suppressants, wetting agents, defoaming surfactants, particulate fillers (as distinct from the long fiber reinforcing filament structures), plasticizers, internal mold release agents, moisture scavengers, pigments, dyes, viscosity reducing inert diluents (preferably those boiling above 260° C. at 1 atmosphere pressure), other surfactants, antistatic agents, coupling agents (for enhancing the bonding of filament to matrix resin), combinations of these, and the like. The optional additives should preferably be used in minor amounts relative to the polymer forming ingredients of the formulation.

The reaction mixture, at the moment it is prepared, is substantially free of organic species, other than carbon dioxide, boiling less than 185° C. at 1 atmosphere pressure (760 mmHg). In a preferred embodiment, the reaction mixture is substantially free of organic species, other than carbon dioxide, boiling less than 195° C. at 1 atmosphere pressure (760 mmHg). In a highly preferred embodiment, the reaction mixture is substantially free of organic species, other than carbon dioxide, boiling less than 200° C. at 1 atmosphere pressure (760 mmHg). In yet another highly preferred embodiment, the reaction mixture is substantially free of organic species, other than carbon dioxide, boiling less than 250° C. at 1 atmosphere pressure (760 mmHg). In a still more highly preferred embodiment, the reaction mixture is substantially free of organic species, other than carbon dioxide, boiling less than 260° C. at 1 atmosphere pressure (760 mmHg). In yet another highly preferred embodiment, the reaction mixture is substantially free of organic species, other than carbon dioxide, having a vapor pressure greater than or equal to 0.1 mmHg at 25° C. In yet another highly preferred embodiment, the reaction mixture is substantially free of any organic species having a vapor pressure greater than or equal to 0.1 mmHg at 25° C. By “substantially free” it is meant that the reaction mixture contains less than 10% by weight of all such organic species combined, relative to the total weight of the reaction mixture (including all optional additives that may be present). More preferably, the reaction mixture contains less than 5% by weight of all such organic species combined, relative to the total weight of the reaction system. Still more preferably, the reaction mixture contains less than 2% by weight of such organic species, even more preferably less than 1%, most preferably less than 0.5%, and ideally less than 0.1%; relative to the total weight of the reaction mixture at the point of mixing. The reaction mixture contains less than 0.1% by weight, and most preferably 0%, of styrene, methyl styrenes, methyl methacrylate, ethyl methacrylate, propyl methacrylates, butyl methacrylates, methyl acrylate, ethyl acrylate, propyl acrylates, butyl acrylates, or any combination of these compounds.

Although filament winding (FW) is a well known manufacturing process in the composite industry, in the last two decades the various types of resins used in this process, the winding equipment, and the software to control the winding process have changed significantly. A few years ago, this process was done using simple two axis winder on a circular rotating mandrel with a fiber delivery system that wound the continues reinforcement as it traveled back and forth along the axis. This simple two-axis FW operation is still widely used to fabricate cylindrical tanks, pipes, poles and tubular products. With the advancement in the winding machines and software control systems, today it is possible to use multi axis equipment (6-7 axis) to wind complex non-circular cross sectional objects such as rectangular, square, ‘T’ pipes, and even 90′-pipe elbows can be wound.

However, the basic principle of wrapping resin-impregnated reinforcement on to the rotating mandrel still remains the same. Rovings, mats (stitched 0-90, ±45) or in general any continues fiber reinforcements are used so as to provide high structural performance to the end product. The most important factors in this process is the wetting of the reinforcement and proper and systematic arrangement of the resin impregnated reinforcement on the mandrel so as to get good compaction and zero void space during the winding process. These all depend upon the proper tension applied on the impregnated fiber just before it is wound on to the mandrel. More recently, the use of resin impregnated chopped strands in conjunction with resin impregnated fibers has also been developed to enhance the performance of the filament wound article (JEC 2002 conference, Paris, by Magnum Venus Products).

Although the FW process is an automatic process, production efficiency depends upon the speed that the wet fibers can be wound (in a controlled fashion), the time required for the resin to cure on the mandrel, and the ease of removing the mandrel after the cure (when necessary). The mechanical properties of the end product are, of course, also very important. The process must be adjusted to produce a product with the desired range of physical properties.

In making simple tubular structures or certain types of tanks, the fiber winding speed may range from 250-500 rpm. This roughly corresponds to laying of 200-300 lbs. of reinforcement/hour. The most commonly used reinforcements in this process are the E-glass, S-glass, aramid fibers (KEVLAR brand fibers) and carbon—graphite fibers. In addition to these common fiber types, natural fibers, or inorganic fibers such as boron, basalt or metal fibers can be used. The resin matrix serves as adhesive to hold the reinforcement together and thus help to transfer the load/force between the fibers that are wound on to the structure. Besides the role of the resin as adhesive, it also provides protection to the reinforcement from external damage and thus overall contributes to the composite toughness (resistance to impacts), cuts and abrasion due to rough handling of the wound part. Also the resin matrix provides certain in-built properties such as hydrolytic, fire, and corrosion resistance to withstand wide range of weather conditions.

Application of Reinforcement Patches During the Winding Process:

In certain embodiments of the filament winding process, it is known in the art to apply patches (of resin treated reinforcing fiber matting) during the winding operation. This is often necessary in the production of certain types of FW tanks or pipes. The reinforcement patches, when used, are placed at several strategic locations (which depend upon the nature of the composite article being manufactured). This is done to provide additional strength to those areas, which come across maximum impact or frequent rough use during the lifetime of the product. For example, additional reinforcement is placed where heating elements and control knobs are located on a typical FW water heater tank. This is usually done by placing the resin impregnated patches and then winding on top of the wet patch. During the winding processes of the prior art, the excess of resin drips at the bottom and is collected in a pan. This dripped resin is used for wetting the patches (which is usually done manually). The excess of dripped resin is discarded at the end of the winding process. The wastage of resin due to dripping and the down time which this can cause makes a significant impact on the economics of the final product. Clearly, it is preferred to reduce or eliminate resin dripping during FW, and particularly during the application of patches.

In the FW process disclosed herein, it has been observed that dripping of excess resin during the winding process, and during application of patches, can be eliminated. The resin viscosity and the reaction profile of the reaction mixture can easily be adjusted so that no dripping occurs during the process. This is much more difficult to accomplish with prior art thermosetting FW processes. Wetting of patches can be accomplished by collecting the reaction mixture from the impregnation bath and then manually wetting the reinforcement. Alternatively, dry reinforcement patches (either one side dry or both sides dry) can be placed on the wound article (such as a tank) during the winding process. It has been unexpected and surprisingly found that all the dry patches were impregnated with the resin from the wound filament and performed the function the same as the wet patch, thereby eliminating a processing step. This is not possible in case of conventional resin systems used in the industry because the prior art resin systems generally fail to wet the patches completely. Incomplete wetting of patches adversely affects the performance of the final FW articles. It was also noted that the characteristics of the resin systems used in the process of the invention were such that it is often possible to reduce or avoid the use of patches.

The invention will be further illustrated by the following non-limiting examples.

### EXAMPLES

In the Examples that follow all percentages given are percentages by weight unless indicated otherwise. All component (A/B) ratios are weight ratios unless indicated otherwise. The B-component composition (polyol blend composition) is defined for each Example. The isocyanate used in each Example is the A-component.

Glossary:

1) JEFFOL G 30-650 polyol: Is an oxypropylated glycerol, nominal triol having an hydroxyl number of about 650, available from Huntsman International LLC.

2) JEFFOL PPG-400 polyol: Is a polyoxypropylene nominal diol having an hydroxyl number of about 255, available from Huntsman International LLC.

3) JEFFOL G 31-32 polyol: Is a flexible polyol having a nominal functionality of 3 and an hydroxyl value of about 32. This polyol is available from Huntsman International LLC.

4) NIAX LC-5615 catalyst: Is nickel acetylacetonate in a polyether carrier, available from Crompton Corporation.

5) DABCO K-15 catalyst: Is potassium 2-ethyl hexanoate, in diethylene glycol carrier. It is available from Air Products and Chemicals Corporation.

6) Baylith Powder 4-A, molecular sieve: Is a synthetic zeolite available from Bayer Corporation. This product has a pore size of about 4 Angstroms, and is suitable as a moisture scavenger.

7) Silquest A-187 silane: Is gamma-glycidoxypropyl trimethoxysilane, available from CD Witco Corporation. This product is suitable for use as a coupling agent for the purpose of improving the bonding of the matrix resin to glass fiber reinforcement.

8) SUPRASEC-9700 polyisocyanate: Is a liquid polymeric MDI product having a free isocyanate group content of about 31.5% by weight and a number averaged isocyanate group functionality of about 2.7. This product is available from Huntsman International LLC.

9) JEFFOL G 30-240 polyol: Is an oxypropylated glycerol, nominal triol, having an hydroxyl number of about 240. It is available from Huntsman International LLC.

10) DABCO DC-2 catalyst: Is a catalyst blend dissolved in a carrier. It is available from Air Products and Chemicals Corporation.

11) JEFFOL SD-441 polyol: Is a sucrose/diethylene-glycol initiated polyoxypropylene polyether rigid polyol having an hydroxyl number of about 440. This product is available from Huntsman International LLC.

12) DPG: Is dipropylene glycol.

13) JEFFOL G 31-35: Is a glycerol initiated polyoxypropylene-polyoxyethylene flexible polyol having an hydroxyl value of about 35. This product is available from Huntsman International LLC.

14) DEG: Is diethylene glycol.

15) SAG-47 surfactant: Is a polydimethylsiloxane based defoaming surfactant, available from Union Carbide Corporation. This product is suitable from use as an antifoaming additive.

16) RUBINATE-8700 polyisocyanate: Is a liquid polymeric MDI product having a free isocyanate group content of about 31.5% by weight and a number averaged isocyanate group functionality of about 2.7. This product is available from Huntsman International LLC.

17) RUBINATE-1790 polyisocyanate: Is a liquid derivative of pure 4,4′-MDI which contains urethane groups, has a number averaged functionality of isocyanate groups of about 2.00 and an isocyanate group content of about 23% by weight. This derivative is commercially available from Huntsman International LLC.

18) DABCO DC-1027 catalyst: Is an amine based catalyst composition, available from Air Products and Chemicals Corporation.

19) FOMREZ UL-29 catalyst: Is an organotin based catalyst composition, available from Witco Corporation.

20) JEFFOL PPG-3706 polyol: Is a polyoxypropylene-polyoxyethylene flexible polyol having a nominal functionality of 2 and an hydroxyl value of about 30. It is available from Huntsman International LLC.

21) DABCO T-45 catalyst: Is potassium 2-ethyl hexanoate dissolved in a polyoxypropylene carrier. It is available from Air Products and Chemicals Corporation.

22) PHOSCHECK P/30 fire retardant: Is an ammonium phosphate based fire retardant additive, available from Monsanto Company.

23) CERECHLOR S-52 fire retardant: Is a chlorinated hydrocarbon fire retardant additive, available from ICI Americas, Inc.

24) CERECHLOR S-45 fire retardant: Is a chlorinated hydrocarbon fire retardant additive, available from ICI Americas, Inc.

25) RUBINATE-7304 polyisocyanate: Is a liquid blend of MDI series polyisocyantes, available from Huntsman International LLC. This blend contains polymeric MDI. The product has an isocyanate group content of about 32.5% by weight, and a number average isocyanate group functionality of less than 2.7 but greater than 2.00.

26) RUBINATE-9258 polyisocyanate: Is a liquid blend of MDI series polyisocyanates, available from Huntsman International LLC. This blend contains polymeric MDI and some uretonimine modified pure MDI. This product has an isocyanate group content of about 32% by weight, and a number averaged isocyanate group functionality of less than 2.7 but greater than 2.0.

27) RUBINATE-9236 polyisocyanate: Is a liquid modified polymeric MDI product which is designed to be emulsifiable. The product contains a minor amount of a reacted emulsifying agent. This polyisocyanate is available from Huntsman International LLC, and has an isocyanate group content of about 31% by weight.

28) RUBINATE-9016 polyisocyanate: Is a liquid blend of MDI series polyisocyanates which contains a partially trimer modified variant of polymeric MDI. This blend, which is available from Huntsman International LLC, has an isocyanate group content of about 31% by weight.

29) RUBINATE-1820: polyisocyanate: Is a liquid blend of MDI series polyisocyanates which contains polymeric MDI. This product is available from Huntsman International LLC, has an isocyanate group content of about 32% by weight, and has a number average functionality of isocyanate groups of less than 2.7 but greater than 2.0.

30) RUBINATE-1920 polyisocyanate: Is a liquid derivative of MDI series polyisocyanates which contains urethane groups, and polymeric MDI. It is available from Huntsman International LLC, has an isocyanate group content of about 27.3% by weight, and has a number averaged functionality of isocyanate groups of less than 2.7 but greater than 2.0.

31) STEPANPOL S-1752 polyol: Is an aromatic polyester based rigid polyol composition which is available from the Stepan Chemical Company. This polyol composition has an hydroxyl value of about 170.

32) STEPANPOL PS-20/200A polyol: Is an aromatic polyester based rigid polyol composition which is available from the Stepan Chemical Company. This polyol composition has an hydroxyl value of about 195.

33) DALTOREZ P-716 polyol: Is an aliphatic polyester nominal diol, available from Huntsman International LLC. This flexible polyol has an hydroxyl value of about 56.

34) DABCO DC-193 surfactant: Is a polysiloxane based surfactant composition, available from Air Products and Chemicals Incorporated.

35) SUPRASEC-2544 polyisocyanate: Is a liquid quasiprepolymer modified derivative of 4,4′-MDI which contains isocyanate terminated prepolymers formed from flexible polyols, and a minor amount of uretonimine modified 4,4′-MDI. This polyisocyanate has an isocyanate group content of about 19% by weight, a number averaged isocyanate group functionality of greater than 2.0 but less than 2.2, and is available from Huntsman International LLC.

36) SUPRASEC-2981 polyisocyanate: Is a liquid quasiprepolymer modified derivative of 4,4′-MDI which contains an isocyanate terminated prepolymer formed from a flexible polyol, and a minor amount of uretonimine modified 4,4′-MDI. This polyisocyanate has an isocyanate group content of about 19% by weight, a number averaged isocyanate group functionality of greater than 2.0 but less than 2.2, and is available from Huntsman International LLC.

37) SUPRASEC-2000 polyisocyanate: Is a liquid quasiprepolymer modified derivative of 4,4′-MDI which contains an isocyanate terminated prepolymer formed from a flexible polyol, and a minor amount of uretonimine modified 4,4′-MDI. This polyisocyanate composition contains a small amount of an inert plasticizer additive. This polyisocyanate has an isocyanate group content of about 17% by weight, a number averaged isocyanate group functionality of about 2, and is available from Huntsman International LLC.

38) SUPRASEC-2433 polyisocyanate: Is a liquid quasiprepolymer modified derivative of 4,4′-MDI which contains an isocyanate terminated prepolymer formed from a flexible polyol, and a minor amount of uretonimine modified 4,4′-MDI. This polyisocyanate has an isocyanate group content of about 19.1% by weight, a number averaged isocyanate group functionality of greater than 2.0 but less than 2.2, and is available from Huntsman International LLC.

39) POGOL-400 polyol: Is a polyoxyethylene glycol of about 400 molecular weight, which is available from Huntsman Corporation.

40) Molecular Sieve: Either BAYLITH 34, BAYLITH 4A, or any mixture thereof. These molecular sieve moisture scavenger products are available from Bayer Corporation.

41) Milled Glass: Short glass fiber filler, OCF 737 BD 1/32″ with silane sizing, having an average fiber length of about 1/32″, 15.8 microns, with normal bulk density of 0.60 g/cc; available from Owens Corning Fiberglass Corp.

42) HUBER CLAY NBK # 680-54, filler: Is a chemically treated hydrated aluminum silicate also called chemically treated Kaolin with less than 1% total crystalline silica manufactured by Huber Engineered Materials, Macon Georgia.

42) KRASOL LB 2000 polyol: Is a hydroxyl terminated polybutadiene flexible polyol having a hydroxyl value of about 51. This product is available from Kaucuk, Kralupy n/V, Czech Republic.

43) Imported oil # 1: Is a long chain fatty acid ester also called castor oil having a hydroxyl value of about 163, acid value of 3 and is available from Caschem Corp., NJ.

44) TECHLUBE BR 550 lubricant: Is a proprietary internal mold release agent containing complex condensation polymers of synthetic resins, glycerides and organic esters, manufactured by Technick Products, Rahway N.J.

45) TERATE 4026 polyol: Is an aromatic polyester polyol with a hydroxyl value of 213 mg KOH/gm. This polyester polyol is believed to be a diol, and is manufactured by Kosa Co. of Wilmington N.C.

46) TERAFLEX 212 polyester: Is an aromatic polyester intermediate having a hydroxyl value of less than 20 mg KOH/gm. It is manufactured by Kosa Co. of Wilmington N.C.

47) BYK K 9600 additive: Is a mixture of oligomeric hydrocarbons with emulsifiers which act as viscosity reducers and pore controllers when used in polyurethane resin systems. It is manufactured by BYK Chemie, of Wallingford Conn.

48) AXEL INT PS 125 additive: Is a proprietary complex mixture of primary and secondary fatty amines with copolymers of organic phosphate esters and fatty acids. It is manufactured by Axel Plastics Research Laboratories, Inc. of Woodside N.Y.

49) Coscat BiZn is a proprietary organobismuth/zinc compound used as a urethane catalyst. CasChem manufactures this product; A Cambrex Company located in Bayonne, N.J.

50) Low moisture castor oil is from Alnor Oil Company located in Valley Stream, N.Y. And has Acid Value of 2 max, Moisture and volatile matter of 0.03% max, Hydroxyl value of 160-168 mg/g KOH and Ricinoleic acid content of 85%.

51) Pale Pressed castor oil is from Alnor Oil Company located in Valley Stream, N.Y. And has Acid Value of 5 max, Moisture and volatile matter of 0.1% max, Hydroxyl value of 160-168 mg/g KOH and Ricinoleic acid content of 85%.

General Filament Winding Process:

The winding process can be done directly on a substrate that can act as a mandrel, or it can be done using a mandrel that is removable or dissolvable after the part is cured. The later type of mandrels are widely used in pipe winding process.

A typical FW set-up comprises a creel holder and a framework mounted on a traverse carriage of the FW machine. The creel holder generally ranges from a few spools to hundreds of spools of similar or different types of reinforcement. The majority of the filament winders use E-glass continues rovings supplied by Owens Corning (366-AC-250, Type 30 glass rovings), Fiber Glass Innovations (Flextrand 1990 Tex, Fiber Dia ‘S’, FGI 199ES700); or similar reinforcement products available from Vetrotex, or from PPG Industries. Typically the reinforcements for FW which have sizings compatible with conventional polyester, vinyl ester, and epoxy resin systems will also give a good adhesion of resin to fiber when used with the isocyanate-based mixing activated resin systems according to the process of the invention. The roving strands or in some instances mats or tapes are pulled from the spool through an overhead stationary creel which puts sufficient tension on the reinforcement to prevent quaternary effect or sagging and thus help to loosen the fiber to promote good wetting. The fibrous reinforcement is then pulled through the resin bath for wetting the fiber. In the impregnation section the reinforcement is covered with a thin coating of resin by means of a resin applicator. Specially modified resin applicators designed and supplied by McClean Anderson Co. are used in the industry for precise control of the resin film applied onto the reinforcement. The impregnation section is designed such that no air is trapped on the fibers. As the resin applicator rotates through the resin tank (bath) the fibers pick up a film of resin. Excess resin on the reinforcement is removed by a doctor blade, which can be manually or mechanically adjusted to limit the amount (thickness) of resin film and squeegees excess resin from the roller into the bath. The optimum thickness of resin film on the reinforcement depends primarily on the resin viscosity. If a resin with low viscosity is used, the blade is set to apply thicker film to the fiber, and vice versa. Typically, the viscosity of the resin system used in FW ranges from 200-800 cps but is not limited to these ranges and could be higher or lower. The resin-impregnated reinforcement is then drawn through a custom control system (also called tension controller) which imparts a constant tension on to the reinforcement. The wet fiber is then drawn through a delivery (feed) eye which places the fiber on to the mandrel. The resin applicator, tension controller, and feed eye are installed on a single framework which is mounted on a horizontal carrier (arm) of the FW machine. The arm of the framework extends during the winding operation carrying the unit back and forth along the horizontal (or vertical) axis of the mandrel and retracts when winding is completed. Each time the framework moves along the length of the mandrel, called a ‘Pass’, the feed eye winds the wet fiber strands on the rotating mandrel at a preset angle. The machine continues to lay the fiber until all the gaps are closed. The software program used during the winding process controls the winding geometry on the mandrel. It is important to note that the wet reinforcement are placed right next to each other on the mandrel and are not overlapped.

The bath is filled with the resin either at the starting of the winding process or is filled automatically as the level of the resin starts to fall below a certain level which is relayed by a light sensor to the resin supply means.

Once the winding is complete, the strands are cut and are physically glued onto the mandrel. The mandrel is then removed from the machine and is kept in the oven adjusted to a certain temperature to cure the resin. Usually the temperature of the oven is kept between 150-300° F. depending upon the cure profile of the resin used in the process. The residence time in the oven is typically from 30 minutes to one hour and in same instance for several hours. After the wound mandrel is cured completely, the mandrel is either removed or the whole unit is sent to the next stage of the production operation.

Polyisocyanate-Based Reactive Filament Winding Process

Two component polyurethane filament winding (2PUFW) was reduced to practice using the following PUR systems (see individual formulations below) for making water heater tanks. The details of winding process used in these Examples are as follows.

E-glass manufactured by Fiber Glass Innovation (FGI), Amsterdam, N.Y. (Tex 1900 and 199ES 700) were used as reinforcement during the winding of water heater tanks. Eight rovings and in some cases seven rovings were pulled from the creels over a series of tension bars to prevent sagging and to loosen the fiber for better wetting. They are then passed through an impregnation chamber (ID 4.5 inch, area, volume capacity of reaction mixture ranging from 150-1500 grams) designed such that no air was entrapped on the impregnated fiber during the wetting process. The amount of resin on the fiber was adjusted by controlling the roller/tension bar present outside and inside the resin bath. The excess resin film was removed by a doctor blade, which restricted the amount of resin on the reinforcement to a thin film. The resin impregnated fibers were then wound (multi-dimensionally) onto an air inflated circular plastic mandrel at a very high speed (250-275 ft/minute) for 16-18 minutes per tank, with occasional line stoppage for adjustments and patch applications on certain areas of the wound tank for additional strength. These patches were made of stitched mats of chopped glass mat glued on one side. The dimension of each patch was approximately 280×180×2 mm.

The filament guides and the delivery eye were used to control the placement of the fibers onto the mandrel. The glass content on a fully wound water heater tank ranges from about 60-65% by weight of the composite article and the resin is in the range of 35-40% by weight. A GS manufactured dual component mix metering machine (Model Little Willie Foamer, LWF, Costa Mesa, Calif.) having a 1:1 fixed weight (100/100) ratio throughput, with air operated valve systems used for dispensing the isocyanate and the polyol blend. The isocyanate and the polyol were pumped at 1:1 ratio through a static mixer having 32 elements into the impregnation chamber. The static mixer was placed 2-3 inches above the impregnation chamber, where it dispensed the reaction mixture into the impregnation chamber at regular intervals. The average was in the range of 4-5 g of resin mixture (reaction mixture) per second. The level of the reaction mixture in the impregnation chamber (the bath) was monitored with the help of a IR level sensor. The level sensor triggered the metering unit to dispense the reaction mixture as the level of the reaction mixture in the bath fell below a certain level.

Typically, it takes around 16-18 minutes to fully wind a water heater tank, with occasional line stoppage for adjustments and patch applications. Once the winding was complete, the part was then removed from the winding machine and was then either transferred into a preheated oven or kept outside on an hanger for more than 30 minutes before it was placed in the oven. The temperature of the hot air oven was adjusted at 155-160° F. and the tank was kept inside the oven for a period of 45-50 minutes for curing. After this process, the sample was then hung on a hook at 25° C. for another 24-48 hours at ambient temperature before testing of mechanical properties. The following are formulations that were used in FW:

### Example A-1

### Formulation

System 1: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL G 30-650 polyol | 53.831 |
| JEFFOL PPG 400 polyol | 26.424 |
| JEFFOL G 31-32 polyol | 17.976 |
| NIAX LC 5615 catalyst | 00.590 |
| DABCO K-15 catalyst | 00.098 |
| SILQUEST A-187 | 01.081 |
| Total. | 100.00 |

Index: 100
Ratio: 1:1
Cup mix reaction profile at 25° C. with 20 seconds slow mix with help of tongue depressor.
   Initiation: 5-6 minutes; Gel: 31-32 minutes; Hardens: 32-34 minutes
Conditions during Filament Winding of Water Heater Tank.
   Temperature: 60-65° F.
   Humidity: 45%

Three filament wound water heater tanks having a capacity of 52 gallons were wound during this trial. The wound tanks appeared to be translucent after the winding was complete. One tank (tank # 1) was allowed to go inside the oven right away whereas the other two tanks (tank # 2 and 3) were kept outside for period of 30 minutes before they were went into the pre-adjusted hot oven. Tank # 1 hardly showed any surface foaming whereas tank # 2 and 3, which were, kept outside the oven for more than 30 minutes showed slight foaming (45% humidity in the air). However, the foaming was only on the outside layer of the winding and was not detected on the inside layer of the wound reinforcement. The results of the cycle and burst test are shown in Table 1.

### Example A-2

### Formulation

System 2: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL G 30-650 polyol | 60.208 |
| JEFFOL PPG 400 polyol | 11.579 |
| JEFFOL G 31-32 polyol | 14.126 |
| DABCO K-15 catalyst | 00.115 |
| BAYLITH Powder 4-A sieve | 01.544 |
| HUBER CLAY NBK # 680-54 | 11.579 |
| SILQUEST A-187 | 00.849 |
| Total. | 100.00 |

Index: 100
Ratio: 1:1 wt/wt or volume/volume
Cup mix reaction profile at 21° C. with 20 seconds slow mix with help of tongue depressor.
   Initiation: 5-6 minutes; Gel: 32-33 minutes; Hardens: 35-36 minutes
Conditions during Filament Winding of Water Heater Tank.
   Temperature: 71-72° F.
   Humidity: 96%

Two filament wound water heater tanks (tank # 4 and 5) having a capacity of 52 gallons were wound during this trial. The wound tanks appeared to be opaque after the winding was complete. Both the tanks were kept outside the oven for more than 30 minutes before they were placed in the hot air blown oven (150-16° F.). The humidity in the plant was around 96%. Both the tanks showed some foaming on the outside surface of the wound tank when it came out of the oven. The results of the UL cycle and burst test are shown in Table 1.

### Example A-3

### Formulation

System 3: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL G 30-650 polyol | 60.181 |
| JEFFOL PPG 400 polyol | 11.573 |
| STEPANPOL PS 20/200 polyol | 14.119 |
| DABCO K-15 catalyst | 00.162 |
| BAYLITH Powder 4-A | 01.543 |
| HUBER CLAY NBK # 680-54 | 11.573 |
| SILQUEST -187 | 00.849 |
| Total. | 100.00 |

Index: 100
Ratio: 1:1 wt/wt or volume/volume
Cup mix reaction profile at 21° C. with 20 seconds slow mix with help of tongue depressor.
   Initiation: 5-6 minutes; Gel: 32-33 minutes; Hardens: 35-36 minutes
Conditions during Filament Winding of Water Heater Tank.
   Temperature: 71-72° F.
   Humidity: 96%

Two filament wound water heater tanks (tank # 6 and 7) having a capacity of 52 gallons were wound during this trial. The wound tanks appeared to be opaque after the winding was complete. Both the tanks were kept outside the oven for more than 30 minutes before they were placed in the hot air blown oven (150-16° F.). The humidity in the plant was around 96%. Both the tanks showed some foaming on the outside surface of the wound tank when it came out of the oven. The results of the UL cycle and burst test are shown in Table 1.

### Example A-4

### Formulation

System 4: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL SD 441 polyol | 26.940 |
| Castor Oil (Imported oil # 1) | 47.140 |
| DABCO K-15 catalyst | 00.175 |
| BAYLITH Powder 4-A | 02.215 |
| DPG | 23.570 |
| Total. | 100.00 |

Index: 125
Ratio A/B:1:1.73 wt/wt or 1:1 volume/volume
Cup mix reaction profile at 21° C. with 20 seconds slow mix with help of tongue depressor.
   Gel: 10-12.5 minutes; Hardens: 13.5-14.5 minutes
Conditions during Filament Winding of Water Heater Tank.
   Temperature: 75° F.
   Humidity: 55%

Two filament wound water heater tanks (tank # 8 and 9) having a capacity of 85 gallons were wound during this trial. The wound tanks appeared to be translucent after the winding was complete and showed no foaming on the surface. Both the tanks were kept outside the oven for more than 30 minutes before they were placed in the hot air blown oven (150-16° F.). The humidity in the plant was around 55%. Both the tanks showed zero foaming on the outside surface when it came out of the oven. The results of the UL cycle and burst test are shown in Table 1. The lack of foaming shows the beneficial effects of the castor oil in this formulation.

### Example A-5

### Formulation

System 5: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL SD 441 polyol | 28.73 |
| KRASOL LB 2000 | 07.48 |
| Castor Oil (Imported oil # 1) | 35.92 |
| DABCO K-15 catalyst | 00.18 |
| BAYLITH Powder 4-A | 02.52 |
| DPG | 25.17 |
| Total. | 100.00 |

Index: 125
Ratio A/B: 1:1.93 wt/wt or 1:1 volume/volume
Cup mix reaction profile at 21° C. with 20 seconds slow mix with help of tongue depressor.
   Gel: 10-12.5 minutes
   Hardens: 13.5-14.5 minutes
Conditions during Filament Winding of Water Heater Tank.
   Temperature: 70-75° F.
   Humidity: 55%

Two filament wound water heater tanks (tank # 10 and 11) having a capacity of 85 gallons was wound during this trial. The wound tanks appeared to be translucent after the winding was complete and showed no foaming on the surface. Both the tanks were kept outside the oven for more than 30 minutes before they were placed in the hot air blown oven (150-16° F.). The humidity in the plant was around 55%. Both the tanks showed zero foaming on the outside surface when it came out of the oven. The results of the UL cycle and burst test are shown in Table 1. The lack of foaming is a beneficial effect of the castor oil in this formulation.

### Example A-6

### Formulation

System 6: Reduced to Practice on a Filament Winding Machine

Isocyanate (“A” component) used: SUPRASEC 9700 isocyanate

Polyol Blend (“B” component) composition:

| Component-B | % |
|---|---|
| JEFFOL G 30-650 polyol | 46.05 |
| JEFFOL PPG 400 polyol | 07.67 |
| JEFFOL G 32-32 polyol | 05.12 |
| Castor Oil (Imported oil # 1) | 38.37 |
| DABCO K-15 catalyst | 00.18 |
| BAYLITH Powder 4-A | 02.61 |
| Total. | 100.00 |

Index: 125
Ratio A/B:1:1.45 wt/wt or 1:1 volume/volume
Cup mix reaction profile at 21° C. with 20 seconds slow mix with help of tongue depressor.
   Gel: 10-12.5 minutes; Hardens: 13.5-14.5 minutes
Conditions during Filament Winding of Water Heater Tank.
   Temperature: 70-75° F.
   Humidity: 55%

Two filament wound water heater tanks (tank # 12 and 13) having a capacity of 85 gallons was wound during this trial. The wound tanks appeared to be translucent after the winding was complete and showed no foaming on the surface. Both the tanks were kept outside the oven for more than 30 minutes before they were placed in the hot air blown oven (150-16° F.). The humidity in the plant was around 55%. Both the tanks showed zero foaming on the outside surface when it came out of the oven. The results of the UL cycle and burst test are shown in Table 1. The lack of foaming here shows the beneficial effects of the castor oil in the formulation.

### Example A-7

System 7: Prophetic Example

Isocyanate (“A” component): SUPRASEC 7304 isocyanate

Polyol Blend (“B” component) composition:

| Component-B | % |
|---|---|
| JEFFOL PPG 1000 polyol | 28.00 |
| Castor Oil (Imported oil # 1) | 67.00 |
| 1,4 Butane diol | 04.82 |
| DABCO DC 2 catalyst | 00.18 |
| Total. | 100.00 |

Ratio A/B:1:1 volume/volume
Cup mix reaction profile at 21° C. with 20 seconds slow mix with help of tongue depressor.
   Gel: 20-22.5 minutes
   Hardens: 23.5-24.5 minutes

### Example A-8

System 8: Prophetic Example

Isocyanate (“A” component): SUPRASEC 7304 isocyanate

Polyol Blend (“B” component) composition:

| Component-B | % |
|---|---|
| Castor Oil (Imported oil # 1) | 99.98 |
| DABCO K 15 catalyst | 00.02 |
| Total. | 100.00 |

Ratio A/B:1:1 volume/volume
Cup mix reaction profile at 21° C. with 20 seconds slow mix with help of tongue depressor.
   Gel: 20-22.5 minutes
   Hardens: 23.5-24.5 minutes
      Note: Certain aliphatic or aromatic oils can also be used in the formulations to impart hydrophobic characteristic to the end product. Also, certain modified isocyanates with hydrophobic backbone can be used to improve the water resistance capability of the final cured product. The hydrophobic backbone may comprise an —NCO terminated prepolymer formed from a hydrophobic polyol such as a polybutadiene diol. Also, certain water resistant catalysts such as bismuth compounds, zinc compounds, titanium compounds, etc. may be used in these types of formulations.

### Example A-9

System 9: Prophetic Example of PUR FW System with IMR

Isocyanate (“A” component): SUPRASEC 8700 isocyanate

Polyol Blend (“B” component) composition:

| Component-B | % |
|---|---|
| JEFFOL G 30 - 650 polyol | 24.191 |
| JEFFOL G 30 - 240 polyol | 36.887 |
| Glycerin | 2.419 |
| NIAX LC 5615 catalyst | 0.726 |
| DABCO DC 2 catalyst | 1.726 |
| BAYLITH Powder 4-A | 1.331 |
| AXEL INT PS 125 | 4.538 |
| Calcium Carbonate | 28.182 |
| Total. | 100.00 |

Ratio A/B:1:1 volume/volume, Index 144
Cup mix reaction profile at 21° C. with 20 seconds slow mix with help of tongue depressor.
   Gel: 15-16.5 minutes
   Hardens: 17.5-18.5 minutes

### Example A-10

System 10: Prophetic Example of PIR FW System with IMR

Isocyanate (“A” component): SUPRASEC 8700 isocyanate

Polyol Blend (“B” component) composition:

| Component-B | % |
|---|---|
| JEFFOL PPG 3706 polyol | 87.994 |
| EG | 05.923 |
| DABCO T-12 catalyst | 00.001 |
| DABCO T-45 catalyst | 00.442 |
| LOXIOL G 71S | 05.640 |
| Total. | 100.00 |

Index 650, Ratio A/B:(wt/wt) 2.08
Cup mix reaction profile at 21° C. with 20 seconds slow mix with help of tongue depressor.
   Gel: 11-12 minutes
   Hardens: 20-22 minutes

### Example A-11

System 11: Prophetic Example of PIR FW System with IMR

Isocyanate (“A” component): SUPRASEC 8700 isocyanate

Polyol Blend (“B” component) composition:

| Component-B | % |
|---|---|
| JEFFOL PPG 3706 polyol | 62.65 |
| DPG | 09.00 |
| DABCO T-45 catalyst | 00.55 |
| Motor Oil 10W30 | 13.90 |
| LOXIOL G 71S | 13.90 |
| Total. | 100.00 |

Index 1200, Ratio A/B:(wt/wt) 2.65
Cup mix reaction profile at 21° C. with 20 seconds slow mix with help of tongue depressor.
   Gel: 4-5 minutes
   Hardens: 5-6 minutes
      Note: If the temperature of the reaction mixture is cooled between 15-18° C. the reaction mixture can be kept liquid for more than 30 minutes. Once the temperature is increased between 55-60° C. the reaction quickly goes to completion in less than 30 seconds.

### Example A-12

System 12: Prophetic Example of PIR FW with Fire Retardant and IMR

Isocyanate (“A” component): SUPRASEC 8700 isocyanate

Polyol Blend (“B” component) composition:

| Component-B | % |
|---|---|
| JEFFOL PPG 3706 polyol | 66.60 |
| DPG | 09.00 |
| DABCO T-45 catalyst | 00.40 |
| Antimony Trioxide | 19.00 |
| TECHLUBE BR 550 | 05.00 |
| Total. | 100.00 |

Index 650, Ratio A/B:(wt/wt) 2.08
Cup mix reaction profile at 21° C. with 20 seconds slow mix with help of tongue depressor.
   Gel: 15-16 minutes
   Hardens: 20-22 minutes

### Example A-13

System 13: Prophetic Example of PUR FW System with Fire Retardant and IMR

Isocyanate (“A” component): SUPRASEC 8700 isocyanate

Polyol Blend (“B” component) composition:

| Component-B | % |
|---|---|
| JEFFOL G 30 - 650 polyol | 32.80 |
| JEFFOL PPG 400 polyol | 16.13 |
| JEFFOL G 30 - 240 polyol | 10.61 |
| AXEL INT PS 125 | 03.93 |
| SILQUEST A 187 | 00.48 |
| BAYLITH Powder 4-A | 03.96 |
| CERECHLOR S 52 | 13.75 |
| Antimony Trioxide | 18.34 |
| Total. | 100.00 |

Ratio A/B: 1:1 wt/wt, Index 160
Cup mix reaction profile at 21° C. with 20 seconds slow mix with help of tongue depressor.
   Gel: 13-14.5 minutes
   Hardens: 16.5-17.5 minutes

### Example A-14

System 14: Prophetic Example of PUR FW System with Fire Retardant and IMR

Isocyanate (“A” component): SUPRASEC 8700 isocyanate

Polyol Blend (“B” component) composition:

| Component-B | % |
|---|---|
| JEFFOL G 30 - 650 polyol | 30.01 |
| JEFFOL PPG 400 polyol | 11.73 |
| TERATE 4026 polyol | 10.67 |
| TERAFLEX 212 | 06.67 |
| AXEL INT PS 125 | 04.00 |
| KENREACT KR 238S | 00.91 |
| BAYLITH Powder 4-A | 02.67 |
| CERECHLOR S 52 | 10.00 |
| Antimony Trioxide | 23.34 |
| Total. | 100.00 |

Ratio A/B: 1:1 wt/wt, Index 169
Cup mix reaction profile at 21° C. with 20 seconds slow mix with help of tongue depressor.
   Gel: 8-10 minutes
   Hardens: 10-12 minutes

### Example-A-15

System 15: Prophetic Example of All Polyester PUR FW System with IMR

Isocyanate (“A” component): SUPRASEC 8700 isocyanate

Polyol Blend (“B” component) composition:

| Component-B | % |
|---|---|
| STEPANPOL PS 1752 polyol | 42.25 |
| Glycerin | 14.09 |
| Trichloro phenyl Phosphite | 10.56 |
| TERATE 4026 polyol | 28.17 |
| BYK K 9600 | 00.70 |
| TECHLUBE BR 550 | 04.32 |
| Total. | 100.00 |

Ratio A/B: 1:1 wt/wt, Index 109
Cup mix reaction profile at 21° C. with 20 seconds slow mix with help of tongue depressor.
   Gel: 12-12.4 minutes
   Hardens: 14-15 minutes

### Example B1

### Reduced to Practice

| Component-B | % |
|---|---|
| JEFFOL G 30 - 650 polyol | 54.419 |
| JEFFOL PPG 400 polyol | 26.713 |
| JEFFOL G 31 - 32 polyol | 18.173 |
| NIAX LC 5615 catalyst | 00.596 |
| DABCO K-15 catalyst | 00.099 |
| Total | 100.0 |

| | |
|---|---|
| Isocyanate Used: | SUPRASEC 9700 isocyanate |
| A/B ratio: | 1:1 |
| Reaction Profile at 25° C.: | Gel 21-22 minutes |
| | Solid/Hard 23-24 minutes |

### Example B2

### Reduced to Practice

| Component-B | % |
|---|---|
| JEFFOL G 30 - 650 polyol | 54.446 |
| JEFFOL PPG 400 polyol | 26.766 |
| JEFFOL G 31 - 32 polyol | 18.142 |
| NIAX LC 5615 | 00.397 |
| BAYLITH Powder 4° A | 00.149 |
| DABCO K-15 | 00.099 |
| Total | 100.00 |

| | |
|---|---|
| Isocyanate Used: | SUPRASEC 9700 isocyanate |
| A/B ratio: | 1:1 |
| Reaction Profile at 25° C.: | Gel 20-21 minutes |
| | Solid/Hard 22-23 minutes |

### Example B3 (Highly Preferred)

### Reduced to Practice

| Component-B | % |
|---|---|
| JEFFOL G 30 - 650 polyol | 53.831 |
| JEFFOL PPG 400 polyol | 26.424 |
| JEFFOL G 31 - 32 polyol | 17.976 |
| SILQUEST A 187 | 01.008 |
| NIAXLC 5615 catalyst | 00.589 |
| DABCO K-15 catalyst | 00.089 |
| Total | 100.00 |

| | |
|---|---|
| Isocyanate Used: | SUPRASEC 9700 isocyanate |
| A/B ratio: | 1:1 |
| Reaction Profile at 25° C.: | Gel 31-32 minutes |
| | Solid/Hard 33-34 minutes |

### Example B4

### Reduced to Practice

| Component-B | % |
|---|---|
| JEFFOL G 30 - 650 polyol | 54.636 |
| JEFFOL PPG 400 polyol | 26.859 |
| JEFFOL G 31 - 32 polyol | 18.205 |
| DABCO K-15 catalyst | 00.300 |
| Total | 100.0 |

| | |
|---|---|
| Isocyanate Used: | SUPRASEC 9700 isocyanate |
| A/B ratio: | 1:1 |
| Reaction Profile at 25° C.: | Gel 10-12 minutes |
| | Solid/Hard 13-15 minutes |

### Example B5

### Reduced to Practice

| Component-B | % |
|---|---|
| JEFFOL G 30 - 650 polyol | 54.473 |
| JEFFOL PPG 400 polyol | 26.779 |
| JEFFOL G 31 - 32 polyol | 18.151 |
| NIAX LC 5615 catalyst | 00.596 |
| Total | 100.00 |

| | |
|---|---|
| Isocyanate Used: | SUPRASEC 9700 isocyanate |
| A/B ratio: | 1:1 |
| Reaction Profile at 25° C.: | Gel 21-22 minutes |
| | Solid/Hard 22-24 minutes |

### Example B6

### Reduced to Practice

| Component-B | % |
|---|---|
| JEFFOL G 30 - 650 polyol | 38.197 |
| Glycerin | 03.773 |
| JEFFOL G 30 - 240 polyol | 54.701 |
| Molecular Sieve | 01.698 |
| DABCO DC 2 catalyst | 00.500 |
| NIAX LC 5615 catalyst | 01.132 |
| Total | 100.00 |

| | |
|---|---|
| Isocyanate Used: | SUPRASEC 9700 isocyanate |
| A/B ratio: | 1:1 |
| Reaction Profile at 25° C.: | Gel 18-19 minutes |
| | Solid/Hard 20-21 minutes |

### Example B7

### Evaluated in the Laboratory

| Component-B | % |
|---|---|
| JEFFOL G 30 - 650 polyol | 37.915 |
| Glycerin | 03.791 |
| JEFFOL G 30-240 polyol | 54.976 |
| SILQUEST A 187 | 00.758 |
| Molecular Sieve | 01.611 |
| DABCO DC 2 catalyst | 00.500 |
| NIAX LC 5615 catalyst | 00.948 |
| Total | 100.00 |

| | |
|---|---|
| Isocyanate Used: | SUPRASEC 9700 isocyanate |
| A/B ratio: | 1:1 |
| Reaction Profile at 25° C.: | Gel 20-21 minutes; |
| | Solid/Hard 21-22 minutes |

### Example B8

### Evaluated in the Laboratory

| Component-B | % |
|---|---|
| JEFFOL G 30 - 240 polyol | 27.273 |
| JEFFOL SD 441 polyol | 50.000 |
| JEFFOL G 31-35 polyol | 04.545 |
| DPG | 16.364 |
| SILQUEST A 187 | 00.909 |
| DABCO DC 2 catalyst | 00.500 |
| NIAX LC 5615 catalyst | 00.909 |
| Total | 100.00 |

| | |
|---|---|
| Isocyanate Used: | SUPRASEC 9700 isocyanate |
| A/B ratio: | 1:1 |
| Reaction Profile at 25° C.: | Gel 23-24 minutes |
| | Solid/Hard 24-25 minutes |

### Example 9

### Evaluated in the Laboratory

| Component-B | % |
|---|---|
| JEFFOL G 30 - 650 polyol | 65.359 |
| JEFFOL PPG 400 polyol | 26.779 |
| JEFFOL G 31 - 32 polyol | 18.151 |
| NIAX LC 5615 catalyst | 00.596 |
| Total | 100.00 |

| | |
|---|---|
| Isocyanate Used: | SUPRASEC 9700 isocyanate |
| A/B ratio: | 1:1 |
| Reaction Profile at 25° C.: | Gel 23-24 minutes |
| | Solid/Hard 24-25 minutes |

### Example B10

### Evaluated in the Laboratory

| Component-B | % |
|---|---|
| JEFFOL G 30 - 650 polyol | 65.359 |
| JEFFOL G 31 - 32 polyol | 32.680 |
| NIAX LC 5615 catalyst | 01.961 |
| Total | 100.00 |

| | |
|---|---|
| Isocyanate Used: | SUPRASEC 9700 isocyanate |
| A/B ratio: | 1:1 |
| Reaction Profile at 25° C.: | Gel 26-27 minutes |
| | Solid/Hard 29-30 minutes |

### Example B11

### Evaluated in the Laboratory

| Component-B | % |
|---|---|
| JEFFOL G 31- 35 polyol | 83.667 |
| DEC | 16.022 |
| SAG 47 | 00.300 |
| DABCO DC 2 catalyst | 00.010 |
| Total | 100.00 |

| | |
|---|---|
| Isocyanate Used: | RUBINATE 8700 isocyanate |
| A/B ratio: | 1:0.5 |
| Reaction Profile at 25° C.: | Gel 50-55 minutes |
| | Solid/Hard 70-80 minutes |

### Example B12

### Evaluated in the Laboratory

| Component-B | % |
|---|---|
| JEFFOL G 31- 35 polyol | 83.667 |
| DEG | 16.022 |
| SAG 47 | 00.300 |
| DABCO DC 2 catalyst | 00.010 |
| Total | 100.00 |

| | |
|---|---|
| Isocyanate Used: | RUBFNATE 1790 isocyanate |
| A/B ratio: | 1:0.5 |
| Reaction Profile at 25° C.: | Gel 60-65 minutes |
| | Solid/Hard 80-90 minutes |

### Example B13

### Laboratory Examples

| Component-B | % |
|---|---|
| JEFFOL G 30 - 650 polyol | 89.192 |
| Glycerin | 06.298 |
| DABCO DC 1027 catalyst | 00.464 |
| FOMREZ UL 29 | 00.046 |
| Molecular Sieve | 03.000 |
| SILQUEST A 187 | 01.000 |
| Total | 100.00 |

| | |
|---|---|
| Isocyanate Used: | RUBINATE 8700 isocyanate |
| A/B ratio: | 1.66, |
| Index: | 105 |
| Reaction Profile at 25° C.: | Gel 8-9 minutes |
| | Solid/Hard 9-10 minutes |
| Reaction Profile at 45° C.: | Gel 1-1.5 minutes |
| | Hard - 20-30 seconds |

Note:
Maintaining the temperature of the reaction mixture between 10° C. and 15 C. retards the reaction thereby preventing it from gelling. But when heated to between 50 C. and 75 C., the reaction goes to completion to form a solid/rigid polymer.

### Example B14

### Laboratory Examples

| Component-B | % |
|---|---|
| JEFFOL PPG 3706 polyol | 61.943 |
| DEG | 12.133 |
| DABCO T-45 catalyst | 00.455 |
| Milled Glass | 19.519 |
| PHOSCHECK P/30 | 04.950 |
| SILQUEST A 187 | 01.000 |
| Total | 100.00% |

Instead of PHOSCHECK P/30 (fire retardant) other fire retardant can also be used such as CERECHLOR S 45, CERECHLOR S 52 (Chlorinated hydrocarbons), Aluminum Trihydrate, Melamine etc to enhance fire performance of the filament wound composite product.

| | |
|---|---|
| Isocyanate Used: | RUBINATE 7304 isocyanate |
| A/B ratio: | 1.08, |
| Index: | 450 |
| Reaction Profile at 25° C.: | Gel 2-3 minutes |
| | Solid/Hard 3-3.5 minutes |
| Reaction Profile at 90° C.: | Gel 40-45 seconds |
| | Hard 50 seconds to 1 minute |

### Example B15

### Prophetic Examples of Polyether Polyester Blend

| Component-B | % |
|---|---|
| JEFFOL G 30 - 650 polyol | 55.479 |
| JEFFOL PPG 400 polyol | 20.849 |
| JEFFOL G 31-32 polyol | 2.691 |
| STEPANPOL S 1752 polyol | 08.322 |
| NIAX LC 6515 catalyst | 00.416 |
| DABCO K 15 catalyst | 00.069 |
| Molecular Sieve | 01.387 |
| SILQUEST A 187 | 00.832 |
| Total | 100.00% |

| | |
|---|---|
| Isocyanate Used: | RUBINATE 8700, RUBINATE |
| | 7304, RUBINATE 9258, |
| | RUBINATE 9236, RUBINATE |
| | 9016, RUBINATE 1820, and |
| | RUBINATE 1920 isocyanates. |
| A/B ratio | 1:1 |

### Example B16

### Prophetic Examples of Polyether Polyester Blend

| Component-B | % |
|---|---|
| JEFFOL G 30 - 650 polyol | 54.795 |
| JEFFOL PPG 400 polyol | 20.548 |
| JEFFOL G 31-32 polyol | 12.534 |
| STEPANPOL S 1752 polyol | 08.219 |
| NIAX LC 6515 catalyst | 00.685 |
| DABCO DC 2 catalyst | 01.027 |
| Molecular Sieve | 01.370 |
| SILQUEST A 187 | 00.822 |
| Total | 100.00 |

| | |
|---|---|
| Isocyanate Used: | RUBINATE 8700, RUBINATE |
| | 7304, RUBINATE 9258, |
| | RUBINATE 9236, RUBINATE |
| | 9016, RUBINATE 1820, and |
| | RUBINATE 1920 isocyanates. |
| A/B ratio | 1:1 |

### Example B17

### Prophetic Examples of Polyether Polyester Blend

| Component-B | % |
|---|---|
| JEFFOL G 30 - 650 polyol | 54.795 |
| POGOL 400 polyol | 20.548 |
| JEFFOL G 31-32 polyol | 12.534 |
| STEPANPOL S 1752 polyol | 08.219 |
| NIAX LC 6515 catalyst | 00.685 |
| DABCO DC 2 catalyst | 01.027 |
| Molecular Sieve | 01.370 |
| SILQUEST A 187 | 00.822 |
| Total | 100.00 |

| | |
|---|---|
| Isocyanate Used | RUBINATE 8700, RUBINATE |
| | 7304, RUBINATE 9258, |
| | RUBINATE 9236, RUBINATE |
| | 9016, RUBINATE 1820, and |
| | RUBINATE 1920 isocyanates. |
| A/B ratio | 1:1 |

### Example B18

### Prophetic Examples of Polyether Polyester Blend

| Component-B | % |
|---|---|
| JEFFOL G 30 - 650 polyol | 54.795 |
| POGOL 400 polyol | 20.548 |
| JEFFOL G 31-32 polyol | 12.534 |
| STEPANPOL PS 20/200A | 08.219 |
| NIAX LC 6515 catalyst | 00.685 |
| DABCO DC 2 catalyst | 01.027 |
| Molecular Sieve | 01.370 |
| SILQUEST A 187 | 00.822 |
| Total | 100.00 |

| | |
|---|---|
| Isocyanate Used | RUBINATE 8700, RUBINATE |
| | 7304, RUBINATE 9258, |
| | RUBINATE 9236, RUBINATE |
| | 9016, RUBINATE 1820, and |
| | RUBINATE 1920 isocyanates. |
| A/B ratio | 1:1 |

### Example B19

### Prophetic Examples of Polyether Polyester Blend

| Component-B | % |
|---|---|
| JEFFOL G 30 - 650 polyol | 54.795 |
| JEFFOL PPG 400 polyol | 20.804 |
| JEFFOL G 31-32 polyol | 12.691 |
| STEPANPOL PS 20/200A polyol | 08.322 |
| NIAX LC 6515 catalyst. | 00.416 |
| DABCO K 15 catalyst | 00.069 |
| Molecular Sieve | 01.387 |
| SILQUEST A 187 | 00.832 |
| Total | 100.00 |

| | |
|---|---|
| Isocyanate Used | RUBINATE 8700, RUBINATE |
| | 7304, RUBINATE 9258, |
| | RUBINATE 9236, RUBINATE |
| | 9016, RUBINATE 1820, and |
| | RUBINATE 1920 isocyanate. |
| A/B ratio | 1:1 |

### Example B20

### Prophetic Examples of Polyether Blend with MDI Based Prepolymers

| Component-B | % |
|---|---|
| JEFFOL PPG 3706 polyol | 47.630 |
| DALTOREZ P 716 | 34.020 |
| 1,4 Butane Diol | 13.610 |
| DEG | 03.420 |
| NIAX LC 5615 catalyst | 00.200 |
| DABCO DC 2 catalyst | 00.030 |
| Glycerin | 00.68 |
| DABCO DC 193 catalyst | 00.41 |
| Total | 100.00 |

| | |
|---|---|
| Isocyanate Used | SUPRASEC 2544, SUPRASEC |
| | 2981, SUPRASEC 2000, and |
| | SUPRASEC 2433 isocyanates |
| A/B ratio | 1:1 |

TABLE 1
Results of the Physical Tests done on
the Polyurethane Filament Wound Tanks.

| | Description | UL Test | Cycle Test | Burst Test | Weight |
|---|---|---|---|---|---|
| Tank # | Of the tank | Pass/Fail | # of cycles | (psi) | (lbs.) |
| 1 | 50 gallon tank | Pass | 101,663 | 550 | 47.75 |
| 2 | 50 gallon tank | Pass | *41407 | ND | 44.85 |
| 3 | 50 gallon tank | Pass | 101,663 | 540 | 44.45 |
| | (Dry patches) | | | | |
| 4 | 50 gallon tank | Pass | 101,000 | 570 | 44.50 |
| 5 | 50 gallon tank | Pass | 101,000 | 550 | 44.70 |
| | (Dry patches) | | | | |
| 6 | 50 gallon tank | Pass | 101,000 | 475 | 44.00 |
| 7 | 50 gallon tank | Pass | 101,000 | 610 | 45.20 |
| | (Dry patches) | | | | |
| 8 | 80 gallon tank | Pass | 101,000 | 550 | 57.20 |
| 9 | 80 gallon tank | Pass | 101,000 | 550 | 60.4 |
| | (Dry patches) | | | | |
| 10 | 80 gallon tank | Pass | 101,000 | 550 | 57.6 |
| 10 | 80 gallon tank | Pass | 101,000 | 550 | 56.5 |
| | (Dry patches) | | | | |
| 12 | 80 gallon tank | Pass | 101,000 | 550 | 57.9 |
| 13 | 80 gallon tank | Pass | 101,000 | 550 | 58.2 |
| | (Dry patches) | | | | |

Note:
*The plastic mandrel/liner failed during the test.

### Example C-1

Evaluated in laboratory

| B-Component Composition | PBW | |
|---|---|---|
| JEFFOL SD 441 polyol | 29.20 | |
| Low Moisture Castor Oil (Alnor Inc.) | 43.01 | |
| 1% Coscat BiZn catalyst diluted in | 01.00 | (varied from 1-5 PBW) |
| JEFFOL PPG 2000 | | |
| DPG | 25.55 | |
| Total | 98.76 | |

A/B Ratio: 1.18
Isocyanate: SUPRASEC 9700 isocyanate
Hand Mix Reaction Profile: @ 25° C. Gel 35-45 minutes, Hard 45-61 minutes

### Example C-2

Evaluated in laboratory

| B-Component Composition | PBW | |
|---|---|---|
| JEFFOL SD 441 polyol | 29.20 | |
| Pale Pressed Castor Oil (Alnor Inc.) | 43.01 | |
| 1% Coscat BiZn catalyst diluted in | 01.00 | (varied from 1-5 PBW) |
| JEFFOL PPG 2000 polyol | | |
| DPG | 25.55 | |
| Total | 98.76 | |

A/B Ratio: 1.18
Isocyanate: SUPRASEC 9700 isocyanate
Hand Mix Reaction Profile: @ 25° C. Gel 50-77 minutes, Hard 77-101 minutes

The above formulations shows no foaming in the cup study as determined by measuring the cup heights containing the reaction mixture before it a starts to react and after the reaction is complete resulting in a cured polymer cake. The cups were cut into two halves vertically and the presence of cellular structure in the polymer matrix was observed using a magnifying lens. Mixing was performed under ambient conditions on a total scale (total reagent weights) of about 150 g in each case. It is desirable to have the minimum possible amount of foaming. The very low (essentially zero) degree of foaming in Examples C-1 and C-2 is believed to be related to the use of the bismuth-zinc catalyst, particularly in combination with castor oil.

It is possible to make castor oil based prepolymers with a wide range of NCO % (15-29%) which can be used in one component and two component filament winding process. Also by adding PPG based polyol such as JEFFOL PPG 1000 polyol or JEFFOL PPG 2000 polyol in various ratios of castor oil to PPG polyols it is possible to make various types of mixed prepolymers which can offer a wide range of physical properties. The details of how such prepolymers can be synthesized are well known in the art. The introduction of castor in the prepolymer would be expected to prevent or reduce foaming, as is the case when the castor oil in placed in the isocyanate-reactive component of the reaction mixture (above). Castor oil based prepolymers are capable, under some circumstances (i.e. films), of undergoing moisture curing when exposed to humid conditions without any foaming This makes them attractive for applications wherein foaming is undesirable, such as filament winding.

1. A reaction system for use in filament winding comprising:
a. an organic polyisocyanate;
b. an organic polyfunctional active hydrogen resin containing a plurality of active hydrogen groups that are reactive towards organically bound isocyanate groups; and
c. optionally, a catalyst that promotes the reaction of organically bound isocyanate groups with active hydrogen groups,
wherein the reaction system is substantially free of styrene, methyl methacrylate, and organic resins or organic monomers boiling at less than 185° C. at 1 atmosphere pressure;
wherein the number averaged functionality of the organic polyisocyanate or the organic polyfunctional active hydrogen resin is greater than two;
wherein the reaction system exhibits a gel time of 1500 seconds or greater, as measured from the completion of mixing at 25° C.; and
wherein the reaction system exhibits a gel time from 25 to 45 seconds, as measured from the completion of mixing at 45° C.

2. The reaction system of claim 1 wherein the organic polyisocyanate is selected from the group consisting of 4,4′-diphenylmethane diisocyanate, 2,4′-diphenylmethane diisocyanate, polymethylene polyphenylene polyisocyanates, and mixtures thereof.

3. The reaction system of claim 1 wherein the reaction system comprises a catalyst and the catalyst comprises bismuth.

4. A reaction system for use in filament winding comprising:
a. an organic polyisocyanate;
b. an organic polyfunctional active hydrogen resin containing a plurality of active hydrogen groups that are reactive towards organically bound isocyanate groups; and
c. a catalyst that comprises bismuth, which catalyst promotes the reaction of organically bound isocyanate groups with active hydrogen groups,
wherein the reaction system is substantially free of styrene, methyl methacrylate, and organic resins or organic monomers boiling at less than 185° C. at 1 atmosphere pressure; and
wherein the number averaged functionality of the organic polyisocyanate or the organic polyfunctional active hydrogen resin is greater than two.

5. The reaction system of claim 1 wherein the reaction system further comprises an inert hydrocarbon oil having an initial boiling point greater than 200° C. at 1 atmosphere pressure.

6. The reaction system of claim 1 wherein the reaction system further comprises at least one member selected from the group consisting of castor oil and isocyanate terminated prepolymers derived from castor oil.

7. The reaction system of claim 1 wherein the reaction system further comprises a fire retardant.

8. The reaction system of claim 1 wherein the reaction system further comprises an adhesion promoter.

9. The reaction system of claim 1 wherein the number averaged functionality of both the organic polyisocyanate and the organic polyfunctional active hydrogen resin is greater than two.

10. A process for producing a filament wound thermoset composite article comprising the steps of:
a. mixing an organic polyisocyanate, an organic polyfunctional active hydrogen resin containing a plurality of active hydrogen groups that are reactive towards organically bound isocyanate groups, and optionally, a catalyst that promotes the reaction of organically bound isocyanate groups with active hydrogen groups in a suitable ratio to form a reaction system;
b. applying the reaction system to a filament in order to form a resin treated filament;
c. winding the resin treated filament around a mandrel in order to form a shaped article; and
d. curing the resin in order to form a cured shaped article,
wherein the reaction system is substantially free of styrene, methyl methacrylate, and organic resins or organic monomers boiling at less than 185° C. at 1 atmosphere pressure;
wherein the number averaged functionality of the organic polyisocyanate or the organic polyfunctional active hydrogen resin is greater than two;
wherein the reaction system exhibits a gel time of 1500 seconds or greater, as measured from the completion of mixing at 25° C.; and
wherein the reaction system exhibits a gel time from 25 to 45 seconds, as measured from the completion of mixing at 45° C.

11. The process of claim 10 wherein the reaction system is substantially free of any organic species, with the exception of carbon dioxide, having a boiling point less than 200° C. at 1 atmosphere pressure.

12. The process of claim 10 wherein the reaction system is substantially free of any organic species having a boiling point less than 260° C. at 1 atmosphere pressure.

13. The process of claim 10 wherein the reaction system is substantially free of any organic species having a vapor pressure greater than or equal to 0.1 mmHg at 25° C.

14. The process of claim 10 wherein the organic polyisocyanate is selected from the group consisting of 4,4′-diphenylmethane diisocyanate, 2,4′-diphenylmethane diisocyanate, polymethylene polyphenylene polyisocyanates, and mixtures thereof.

15. The process of claim 10 wherein the reaction system comprises a catalyst and the catalyst comprises bismuth.

16. A process for producing a filament wound thermoset composite article comprising the steps of:
a. mixing an organic polyisocyanate, an organic polyfunctional active hydrogen resin containing a plurality of active hydrogen groups that are reactive towards organically bound isocyanate groups, and a catalyst that comprises bismuth, which catalyst promotes the reaction of organically bound isocyanate groups with active hydrogen groups in a suitable ratio to form a reaction system;
b. applying the reaction system to a filament in order to form a resin treated filament;
c. winding the resin treated filament around a mandrel in order to form a shaped article; and
d. curing the resin in order to form a cured shaped article,
wherein the reaction system is substantially free of styrene, methyl methacrylate, and organic resins or organic monomers boiling at less than 185° C. at 1 atmosphere pressure; and
wherein the number averaged functionality of the organic polyisocyanate or the organic polyfunctional active hydrogen resin is greater than two.

17. The process of claim 16 wherein the reaction system further comprises at least one member selected from the group consisting of castor oil and isocyanate terminated prepolymers derived from castor oil.

18. The process of claim 10 wherein the reaction system further comprises a fire retardant.

19. The process of claim 10 wherein the reaction system further comprises an adhesion promoter.

20. The process of claim 10 wherein the reaction system further comprises an inert hydrocarbon oil having an initial boiling point greater than 200° C. at 1 atmosphere pressure.

21. The process of claim 10, wherein the polyfunctional active hydrogen resin comprises at least one hydrophobic polyol selected from the group consisting of hydrocarbon backbone polyols and fatty polyester polyols.

22. The process of claim 10, wherein the organic polyisocyanate comprises an isocyanate terminated prepolymer derived from at least one hydrophobic polyol selected from the group consisting of hydrocarbon backbone polyols and fatty polyester polyols.

23. The process of claim 10 wherein the number averaged functionality of both the organic polyisocyanate and the organic polyfunctional active hydrogen resin is greater than two.

24. The process of claim 10, wherein the resin cures by forming a covalently crosslinked network structure.
